(19) United States
(12) Patent Application Publication
(10) Pub. No.: US 2015/0123794 A1
(43) Pub. Date: May 7, 2015

(54) METHOD AND APPARATUS FOR RECORDING LOCATION SPECIFIC ACTIVITY OF A USER AND USES THEREOF

(71) Applicants: Jari Hämäläinen, Kangasala As (FI); Ismail Mohamud, Flower Mound, TX (US); Federico Fraccaroli, Irving, TX (US); Saswat Misra, New York, NY (US)

(72) Inventors: Jari Hämäläinen, Kangasala As (FI); Ismail Mohamud, Flower Mound, TX (US); Federico Fraccaroli, Irving, TX (US); Saswat Misra, New York, NY (US)

(21) Appl. No.: 14/535,280

(22) Filed: Nov. 6, 2014

Related U.S. Application Data
(60) Provisional application No. 61/900,731, filed on Nov. 6, 2013.
(60) Provisional application No. 61/900,758, filed on Nov. 6, 2013.
(60) Provisional application No. 61/901,729, filed on Nov. 8, 2013.
(60) Provisional application No. 61/901,752, filed on Nov. 8, 2013.
(60) Provisional application No. 61/901,774, filed on Nov. 8, 2013.
(60) Provisional application No. 61/928,221, filed on Jan. 16, 2014.

(51) Int. Cl. G01S 3/14; G07C 9/00; G06Q 30/02; G01S 3/04

(52) U.S. Cl. CPC G01S 3/14; G01S 3/046; G07C 9/00111; G06Q 30/0261; G06Q 30/0267
USPC 340/539.13

(57) ABSTRACT

A method and an apparatus for recording information is disclosed. A user is identified based on a user ID. The user is tracked based on the user ID and a determined present location. User metadata is tagged at the identified present location. User presence at the present location is recorded.

### RELATED APPLICATIONS

This application claims priority from U.S. Provisional Patent Application Ser. No. 61/900,731 filed on Nov. 6, 2013; Ser. No. 61/900,758 filed on Nov. 6, 2013; Ser. No. 61/901,729 filed on Nov. 8, 2013; Ser. No. 61/901,752 filed on Nov. 8, 2013; Ser. No. 61/901,774 filed on Nov. 8, 2013; Ser. No. 61/928,221 filed on Jan. 16, 2014.

### TECHNICAL FIELD

The present application generally relates to an activity monitoring system and more particularly to a method and apparatus for recording location specific activity of a user, systems and methods for providing instructions to a user (e.g., walking or driving directions) to improve the user's connection to one or more access points, a method and apparatus for delivering an advertisement to a user using a radio frequency identification tag, a method and apparatus for providing an RFID enabled smart mailbox system, and network-based techniques for the rental and lease of products using human identification (ID)

### BACKGROUND

With a surge in social networking sites across the globe, a number of platforms where a user can share and maintain a record of memories and experiences have come into existence. The memories and experiences may be captured by the user using an image capturing device that is configured to perform recording such as video recording, image capturing, audio recording, and the like. Generally, the user is required to carry the image capturing device for capturing the memories and experiences while travelling. However, it may not be possible for the user to carry the image capturing device every time. For example, if a family visits an amusement park and each member of the family is riding on a speedy ride on a swing, it may not be possible for the user, such as a member of the family, to record a video of the family while on the ride. In such a scenario either the user is dependent on other users to record the video or the recording may not turn out to be of good quality. Hence, it may be beneficial to provide a method for automatically recording such as the video for the user in such a manner that, the users do not have to depend on anyone for capturing their memories and experiences.

Further, the automatic recording is useful for user surveillance and security purposes. For example, a user may be a crime suspect and a crime investigation unit may need to maintain a close watch on the crime suspect to track his activities. In such a scenario, it may be advantageous to monitor the activities of the crime suspect using automatic video recording equipment. Thus, there exists a need for systems and methods that may provide automatic recording of the activities of the user.

Existing smartphone-based signal mapping services provide a user with a graphical view of signal strength across a geographic area on the display of a smartphone. Some of these services guide a user (e.g., provide walking or driving directions) to a nearby location where the service has determined the user will have a higher quality signal to access. For example, OpenSignal is a phone-based wireless mapping service that displays signal strength “heat maps” for cellular and WiFi data connections. OpenSignal further displays estimated locations of WiFi hotspots overlaid over a three-dimensional map of an area. Each WiFi location includes an indication of associated signal strength in the form of one or more “signal strength bars.” Further, a graphical arrow is used to “guide” a user of the OpenSignal application via walking directions to a nearby access point. Similarly, Sensorly.com, provides a mobile application that allows a user to access signal strength heat maps across a range of network providers (e.g., Sprint and Google) so that a user can choose a “best carrier” for their intended use.

OpenSignal, Sensorly.com, and related mobile services generally source their data entirely from cloud based data delivered from a remote server. Accordingly, it would be desirable, additionally or alternatively, to generate heat map data for a smartphone from the smartphone's own self-reported measurements of signal strength and data reported directly from other smartphones in the vicinity via mobile-to-mobile communications links.

OpenSignal, Sensorly.com, and related mobile services generally base their respective heat maps and guided directions on measured signal strength (e.g., amplitude), which in practice may differ significantly from an actual throughput achievable by a user. For example, a WiFi access point may be associated with a high measured signal strength but may provide low to moderate actual throughput due to a large number of active users. Accordingly, it would be desirable to provide a user with a heat map and related services that more accurately represent a throughput experienced by that user. Further, services such as those described above typically source their data entirely from cloud based data delivered from a remote server. Accordingly, it would be desirable to additionally or alternatively generate data for a smartphone from the smartphone's self-reported measurements of signal strength and from direct mobile-to-mobile connections to other phones in the vicinity.

Further, OpenSignal, Sensorly.com, and related mobile services generally collect data using a standard omni-directional type antenna. It is generally difficult to translate data received from such an antenna into directional elements and this thus limits the ability of these applications to provide accurate directional instructions to a user, especially when limited data is available. Accordingly, it would be desirable to incorporate more accurate directional techniques, including more directional antennas, into the mobile application.

Radio frequency identification (RFID) systems are commonly used for identifying or tracking the location of physical objects in manufacturing, supply chain management, and retail inventory control. Typically, the RFID systems include a RFID tag that may be affixed to the physical object and a RFID reader that is used for retrieving information from the RFID tag. The RFID tag includes a memory configured to store a unique identification (ID) of the RFID tag and information associated with the object, an antenna for establishing a wireless communication with the RFID reader and other electronic circuits. The unique ID and information stored in the RFID tag can be extracted from the RFID tag whenever the RFID tag is present within a communication of the RFID reader.

The information stored in the RFID tags can be application specific information which is dependent on an environment for which the RFID system has been developed. For example, in a retail store, the information in the RFID tag may include cost and associated discounts available on purchase of the object. Further, it may be required to provide advertisements to the user for one or more objects in the retail store so that the user may purchase the object later. For example, when a user terminal equipped with the RFID reader interacts with the RFID tag attached to a refrigerator, an owner of the retail store may be interested in providing advertisement of objects such as an air conditioner, or any other cooling device to the user. The owner needs to be rewarded for delivery of advertisements from advertisers. Therefore, there is a need for providing a system to enable reward based delivery of advertisements to the users when the user terminal equipped with the RFID reader interacts with the RFID tag attached to the object.

Traditional mailboxes are passive pick and drop devices where a postman can drop regular correspondence, which can be later checked and picked up by a mailbox owner, such as a residential or corporate mailbox owner. The mailbox owner then has to check the complete set of correspondence and sort the correspondence. Thus, in traditional mailboxes, the mailbox owner may need to go through all the couriers one by one to identify and sort them. Any urgent correspondence, such as bills and time sensitive mails cannot be automatically brought to the notice of the mailbox owner on priority. Moreover, with a lot of advertisements and other junk correspondence being delivered at the traditional mailboxes, important correspondence may get easily missed or misplaced, causing loss to the mailbox owners. Additionally, as most of the traditional mailboxes are deployed outside the house or office of the mailbox owner, the mailbox is easily accessible to any passerby. In the event that a passerby tries to tamper with the traditional mailbox, the mailbox owner would not get to know. Thus, it would be beneficial to have the traditional mailboxes equipped with capabilities for informing the mailbox owners regarding pending correspondence, urgent correspondence, mailbox tampering, and other courier related details.

Various techniques are developed to address shortcomings of the traditional mailbox. In an example, a radio-frequency identification (RFID) technique is used wherein delivery related information regarding the couriers is provided to the mailbox owner. The delivery related information may include identification information of the mailman at the mailbox, and may be used for tracking the courier or correspondence delivery and receipt confirmation. In another example, technologies such as QR code based identification, Optical Character Recognition (OCR), barcodes etc. may also be used for object tracking and identification. These technologies may be used to equip traditional mailboxes with capabilities for courier tracking, correspondence tracking, and delivery tracking. While such technologies add certain functionalities to traditional mailboxes, they fail to address other functions like marking and prioritizing urgent correspondence. There exists a need for a smart mailbox which can provide some enhanced services, like prioritizing urgent couriers and correspondence, avoiding mailbox tampering, avoiding misplacing of important couriers and the like.

The rental and lease of products often requires that a user provide a down payment for the use the product. The down payment provides some assurance to the rentor or leasor that the product will be returned and also provides a “safety net” should the product be partially damaged or worn-out upon return so as to need repair. However the requirement of a down payment makes some renters and leasers (“users”) reluctant to do business. In general, all users of a product are charged the same amount of money (and assessed the same down payment) for a renting or leasing a given product for a given amount of time. This is true despite the fact that different users will treat the product in ways that will cause very different costs to the rentor or leasor upon the product's return or at some time down the line. For example, some users may put heavy wear and tear on a product, thus creating much cost for the rentor or leasor, while other users may barely handle the product.

The present application draws synergies and connections between the technologies described. All the patents, patent applications and published documents mentioned anywhere in this application are incorporated herein by reference in their entirety.

Furthermore, where a definition or use of a term in a document that is incorporated by reference is inconsistent or contrary to the definition of that term provided herein, the definition of that term provided herein applies and the definition of that term in the reference does not apply.

### SUMMARY

According to a first aspect of the invention, a method and an apparatus for recording information is disclosed. A user is identified based on a user ID. The user is tracked based on the user ID and a determined present location. User metadata is tagged at the identified present location. User presence at the present location is recorded.

Accordingly, presented herein are techniques for providing connectivity information to a user and, more particularly, to systems and methods for providing instructions to a user (e.g., walking or driving directions) to improve the user's connection to one or more access points. In more detail, presented herein are techniques for generating throughput information for a user of a mobile device. A request for end-to-end throughput information is received. In response to the request, information on end-to-end throughput values associated with at least one access point at a plurality of locations relative to the access point is received. An end-to-end throughput value at a current location is compared to throughput values at the plurality of locations. The user is provided with one of a visual heat map and movement directions. The retrieved end-to-end throughput information includes at least one reading from the mobile device or from another mobile device via a mobile-to-mobile communications link.

The techniques of the present disclosure provide for accurate representations of end-to-end throughput experienced by a user and for directional antenna-based techniques.

According to one aspect of the invention, a method and an apparatus for communicating advertising are disclosed. An object affixed with an RFID tag are selected. A unique ID of the RFID tag is received. An advertisement associated with the unique ID of the RFID tag is determined. The advertisement is delivered to a user terminal.

According to one aspect, the present invention relates to techniques for managing mail. A courier ID is transmitted. A courier is identified based on the courier ID. Courier information is retrieved from the identified courier. Mail is sorted based on the courier information.

Accordingly, presented herein are network-based techniques for the rental and lease of products using human ID. The disclosed techniques allow charges to be assessed via electronically stored payment methods and so avoid the complication associated with down payments. Further, the disclosed techniques are able to track and assess the per-user wear and tear caused to a product during a rental or lease period and, more generally, are able to assess different charges to different users based on a wide variety of criteria.

In more detail, disclosed herein are techniques for renting or leasing a product using human ID. A user selection of a product for purchase or rental is 2 received. A personal human ID of the user is identified. A network-based representation of the user's personal human ID is identified. The product is associated with the network-based representation of the user's personal human ID. At least one aspect of the product or use of the product is tracked through the network-based representation.

The techniques of the present disclosure provide a method for generating throughput information for a user of a mobile device, the method comprising: receiving a request for end-to-end throughput information; in response to the request, retrieving information on end-to-end throughput values associated with at least one access point at a plurality of locations relative to the access point; comparing an end-to-end throughput value at a current location to the plurality of locations; and providing the user with one of a visual heat map and movement directions.

The method provides that the retrieved end-to-end throughput information includes at least one reading from the mobile device or via a direct mobile-to-mobile link from another mobile device in its vicinity.

The method provides that the retrieved information on end-to-end throughput values is associated with a plurality of access points and wherein the plurality of access points include at least on WiFi-based access point and one cellular protocol-based access point.

The method provides that the retrieved data includes a first set of data providing relating to omni-directional reported data and a second set of data providing data relating to directional antenna reported data.

The method provides that movement directions are provided to the user in response to a determination that the end-to-end throughout value at the present location is sufficiently smaller than an end-to-end throughput value at at least one of the plurality of locations.

The method further comprises receiving a user toggle between a directional antenna mode and an omni-directional antenna mode and retrieving a subset of information from the database based on the mode.

The method further comprises providing the user with angle-based movements to align the direction of the user's antenna.

The method provides that the mobile devices houses both an omni-directional antenna and a directional antenna.

The method provides that the request is auto generated based on a background detection that an achievable signal strength is sufficiently large.

The method further comprises determining an indoor confines in which the mobile device is located, and preloading indoor mapping data based on the indoor confines; and presenting the visual heat map based on the retrieved indoor confines.

The method provides that the visual heat map changes dynamically in real-time as the phone is rotation in place to reflect the position variant gains achievable using a directional antenna.

The techniques of the present disclosure provide a method for managing mail, the method comprising: transmitting a courier ID; identifying a courier based on the courier ID; retrieving courier information from the identified courier; and sorting mail based on the courier information.

The method further comprises communicating the courier information over a remote network.

The method further comprises determining whether the courier information can be validated; and unlocking a smart mailbox to deliver mail and perform enhanced functions in response to determining that the courier information can be validated.

The method further comprises determining whether the courier information can be validated; and blocking mail in response to determining that the courier information cannot be validated.

The method provides that the courier is a private organization.

The techniques of the present disclosure provide a method for renting or leasing a product using human ID, the method comprising: receiving a user selection of a product for purchase or rental; identifying a personal human ID of the user; identifying a network-based representation of the user's personal human ID; associating the product with the network-based representation of the user's personal human ID; and tracking at least one aspect of the product or use of the product through the network-based representation.

The method further comprises assessing a charge to the user based on the tracked at least one aspect of the product or use of the product.

The method provides for identifying the personal human ID of the user comprises requiring the user to make an in-person visit to a commercial site to have the personal human ID of the user verified by a staff of a company providing the product or by staff of an independent third-party company.

The method provides for the network-based representation of the user's personal human ID comprises a company-specific account number for the user.

The method provides for tracking at least one aspect of the product or use of the product comprises receiving, at a company server, information on the product or use of the product, wherein the signal transmitted from circuitry of the product via at least one of a cellular signal, WiFi signal, and Bluetooth signal.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an exemplary architecture of a system for monitoring a location based activity of a user according to an embodiment of an invention;

FIG. 2 illustrates an exemplary block diagram depicting exemplary tables in a database used for recording the location based activity of the user according to an embodiment of an invention;

FIG. 3 illustrates an exemplary method for providing location based activity recording of the user in an amusement park; and

FIG. 4 illustrates an exemplary method for retrieving the recorded activities of the user according to an embodiment of the invention.

FIG. 5 depicts an illustrative process for generating heat map data for a smartphone from the smartphone's own self-reported measurements of signal strength and data reported directly from other smartphones in the vicinity via mobile-to-mobile communications links in accordance with an embodiment.

FIG. 6 depicts an illustrative process for generating a heatmap using a mobile device incorporating an omnidirectional antenna in accordance with an embodiment.

FIG. 7 illustrates an exemplary architecture of a radio frequency identification (RFID) based system configured to deliver an advertisement and reward associated therewith, according to an embodiment of the invention;

FIG. 8 illustrates an exemplary method for storing an ownership of a RFID tag according, to an embodiment of the invention;

FIG. 9 illustrates an exemplary method for providing rewards to an owner of the RFID tag on delivery of an advertisement to a user, according to an embodiment of the invention; and

FIG. 10 illustrates an exemplary method for sharing the rewards among the owners of the RFID tags and at least one user.

FIG. 11 illustrates an exemplary embodiment of a smart mailbox system;

FIG. 12 illustrates an exemplary embodiment of a method of using the smart mailbox, according to an embodiment of the invention;

FIG. 13 illustrates an exemplary embodiment of a method of using the smart mailbox using courier validation, according to an embodiment of the invention.

FIG. 14 depicts an illustrative network-based process for renting or leasing products to a user based on human ID in accordance with an embodiment.

### DETAILED DESCRIPTION OF THE DRAWINGS

Hereinafter, embodiments of the presently-disclosed systems and methods for providing connectivity information to a user and, more particularly, to systems and methods for providing instructions to a user (e.g., walking or driving directions) to improve the user's connection to one or more access points are described with reference to the accompanying drawings. Like reference numerals may refer to similar or identical elements throughput the description of the figures.

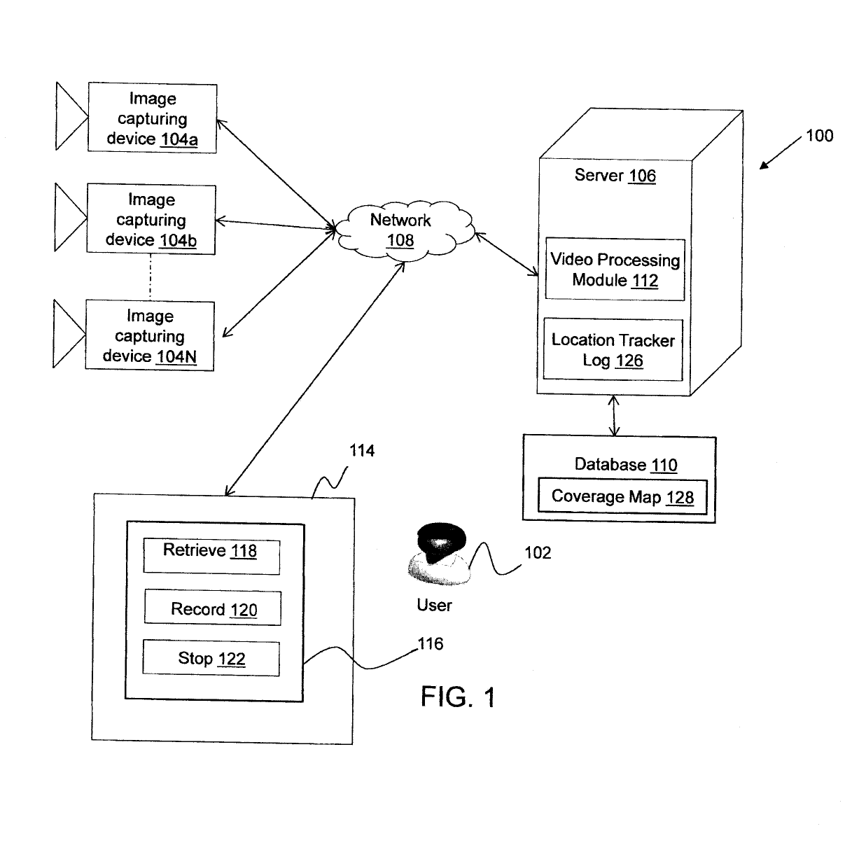

FIG. 1 illustrates an exemplary architecture of a system 100 for monitoring a location based activity of a user 102 according to an embodiment of the invention. The system 100 is configured to record the activities of the user 102 at different locations. Such recording of the activities of the user 102 may be used for either personal viewing of the user 102 or for tracking the user for security purposes. For example, the user 102 may extract recordings at different locations from the system 100 for personal usage such as to view the activities recorded at an amusement park or at any other event gathering at that location. In another example, a security agency may identify the user 102 and monitor the location specific activities of the user 102 to determine any fraudulent or criminal activities associated with the user 102.

As illustrated, one or more image capturing devices (referred herein to as an image capturing device 104) such as an image capturing device 104a, an image capturing device 104b and an image capturing device 104n are configured to capture images of the user 102 at different locations. That is to say, each of the image capturing devices 104 has a respective coverage area and is configured to record activities of the user 102 when the user 102 is available in the respective coverage area of the image capturing device 104. The one or more image capturing devices 104 can include any device that captures an image by gathering light through its aperture, including a digital camera, a video camera, video recorder, a still image capture device, and any other image capturing devices. Further, the image capturing device 104 may be configured to include an image processing system including a computer-readable medium and one or more processors for storing, processing, transmitting image data, and controlling the image capturing device 104.

Each of the image capturing devices 104 is a network capable device and is configured to connect with a server 106 through a network 108. The network 108 may be a wired or any type of wireless network, including, but not limited to Wi-Fi networks, cell phone networks, as well as any other type of network. Furthermore, network 108 may be associated with any type of network standard including, but not limited to CDMA, TDMA, GSM, AMPS, PCS, analog and/or W-CDMA. The server 106 is configured to control the image capturing device 104 through the network 108 so as to monitor the activities of the user 102 at the different locations covered by the respective image capturing devices 104. In an example, the server 106 is configured to remotely control the configuration parameters of the image capturing device 104. The configuration parameters of the image capturing device 104 may include but are not limited to, an identification (ID) of the image capturing device 104, a recording format or an image format, compression enablement and compression technology selection, date or timing parameters, network configuration, host name, system information, and any other operation control related parameters.

In an example, the server 106 is configured to provide instructions to the image processing system of the image capturing device 104 such as to record a video or images of one or more objects in the respective coverage area. Subsequently, the recorded video or the captured images are transferred to the server 106 which may be configured to store the recorded video or the captured images in a local storage or in a database 110. In an example, the server 106 may be configured to store the recorded video or the captured images in combination with the ID of the image capturing device 104 in the database 110. The database 110 can be any one or a combination of databases such as a hierarchical database, network database, relational database, object-oriented database and the like.

Further, the server 106 may be configured to extract the recorded video or the captured images specific to the user from the database 110 using a video processing module 112. For this, a retrieval request for the recorded video or the images of the user 102 from the database 110 may be transmitted to the server 106. In one embodiment, the retrieval request may be transmitted by the user 102 using a computing device 114. The computing device 114 is a network-capable device, such as a computer, a laptop, personal digital assistant (PDA), a mobile telephone, a pager, and any other computing device configured to communicate with the server 106. The computing device 114 is configured to provide an interface 116 to the user 102 through which the user 102 may select a retrieve 118 option to issue the retrieval request to the server 106. In another embodiment, the retrieval request may be sent to the server 106 by a third party for tracking the activity of a specific user such as the user 102. The third party may indicate the user ID of the specific user and submit a request to the server 106 for retrieving the recorded videos or images of the specific user at different locations.

On receiving the retrieval request, the server 106 may be configured to process a location tracker log 126 to determine the presence of the user 102 at the different locations. The location tracker log 126 may also include the timings during which the user 102 is present at the different locations. The server 106 is further configured to determine the IDs of the image capturing devices 104 available at the locations at which the user 102 is located. The server 106 may utilize a coverage map 128 such as to determine the presence of the user 102 within the coverage of one or more image capturing devices 104. The coverage map 128 may indicate geographical area which can be captured by the one or more image capturing devices 104.

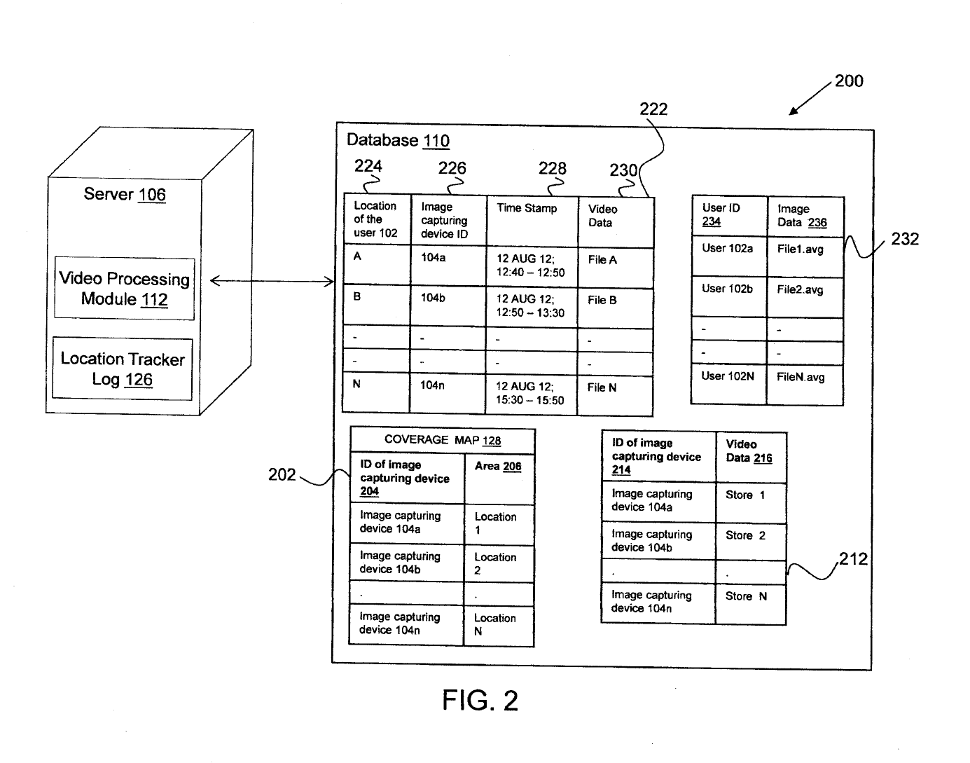

Subsequently, the server 106 is configured to generate a table indicating the availability of the user 102 at the different locations, the IDs of the image capturing devices 104 at the respective locations and timings of the presence of the user 102 at the different locations. The video processing module 112 utilizes this table and the presence timings of the user 102 to generate a video for the user 102 such that information indicating the activities of the user 102 is generated from the recorded videos or images of the image capturing devices 104 located at the different locations. The process of recording activities of the user 102 is further explained in detail with reference to FIG. 2.

In an embodiment, the server 106 may be configured to provide an interface to the user 102 such that user 102 can control the recordings using the interface 116. For example, computing device 114 may include interface options such as the record 120 option and the stop 122 option so as to transmit requests to the server 106 to record or to stop recordings of the user 102 respectively. The user 102 may select the record 120 option to initiate storage of videos that indicate the activities of the user 102 at the different locations which are within the range of the image capturing devices 104. As the user selects the record 120 option, the computing device 114 transmits the ID of the user 102, a current location of the user 102, and a request to record the activities of the user 102 to the server 106.

On receiving the request, the server 106 may be configured to determine an ID of the image capturing device 104 which is in the geographic coverage range of the current location of the user 102 using the coverage map 128. For example, the server 106 may compare the current location of the user 102 with a geographical range associated with a first image capturing device 104. If the current location of the user 102 is within the geographical range associated with the first image capturing device 104, the ID associated with the particular image capturing device 104 is selected. Further, the server 106 determines the duration for which the user 102 is present within the geographical range associated with the first image capturing device 104. Accordingly, the video processing module 112 extracts the recorded video of the first image capturing device 104 for the determined duration and stores the extracted video against the ID of the user. Further, the computing device 114 may transmit the updated location information of the user 102 to the server 106 and the server 106 may identify a second image capturing device 104 depending on the updated location information of the user 102. The server 106 also determines duration of the presence of the user 102 within the geographical range of the second image capturing device 104. Similarly, the video processing module 112 extracts the recorded video of the second image capturing device 104 for the determined duration and stores the extracted video against the ID of the user 102. Further, the user 102 may select the stop 122 option to request the server 106 to stop storage of the activities of the user 102.

In an embodiment, the system 100 may be configured to record activities of the user 102 without providing any control interface to the user 102. For example, the system 100 may employ one or more sensors at the different locations to determine the presence of the user 102 at a first location. The sensors may be configured to detect the ID associated with the user 102. Further, the system 100 is configured to determine the duration of the presence of the user 102 at the first location using the one or more sensors. In an example, the system 100 may install a first sensor at an entry point of the first location and a second sensor at an exit point of the first location. The detection of the user at the entry point and the exit point may be used for determining the duration of the presence of the user 102 at the first location. Accordingly, the video processing module 112 extracts the recorded video of a particular image capturing device 104 at the first location and stores the extracted video against the ID of the user 102.

In an embodiment, the server 106 may provide an interface to other users to add or remove the one or more image capturing devices 104 in the system 100 so as to dynamically modify the geographical range in the coverage map 128. The system 100 may provide incentives to the users who may have made available their own image capturing devices 104 to record the activities of the user 102. Further, various options may be shown to the user 102 so as to select packages for recording the activities of the user at the different location. Such packages may be offered by the event organizers, amusement park authorities, and any other commercial entities, which may be interested in providing activity recording features to the users.

FIG. 2 illustrates an exemplary block diagram 200 depicting exemplary tables in the database 110 for recording the location based activity of the user 102 according to an embodiment of an invention. The database 110 may be configured to include the coverage map 128 in the form of a table 202 that includes at least two columns such as a column 204 and a column 206. Each entry in the column 204 may indicate an identification of each of the image capturing devices 104 available in the system 100 for recording the activities of the user 102 at the different locations. Each entry in the column 206 may indicate a geographical area that is covered by the respective image capturing device 104 as listed in the column 204. In an example, a geographic area may indicate location coordinates of a starting and an ending point of the coverage area of the image capturing device 104. As discussed above, the server 106 may be configured to compare the current location of the user 102 with the areas listed in the column 206 to identify the ID of the image capturing device 104.

The database 110 is configured to include video storage table 212 such as to identify the storage location of recorded videos or captured images from the one or more image capturing devices 104. The video storage table 212 includes two columns such as a column 214 and a column 216. The column 214 indicates the identification of the one or more image capturing devices 104 and the column 216 indicates a pointer toward the storage location of the recorded videos or captured images from the respective one or more image capturing devices 104 as listed in the column 214.

The database 110 is further configured to include a user information table 222 so as to track the activities of the user 102 by the corresponding image capturing devices 104 at the different locations. The server 106 is configured to maintain a table similar to the table 222 for each user of the system 100. Further, the number of columns in the table 222 is an exemplary number and the columns may change depending on the requirements as communicated by the server 106. As illustrated, the table 222 may include a column 224 pertaining to the presence of the user 102 at the different locations. For example, the user 102 may roam in an amusement park and have presence at the different locations at different times in the amusement park.

Such presence of the user 102 at the different locations in the amusement park may be tracked using one or more sensors installed at the respective locations of the amusement park. In an example, tracking may be done based on using radio frequency identification (RFID) techniques wherein an RFID tag is associated with the identification of the user 102 and one or more RFID readers are installed at the different locations. The RFID tag is configured to store identification information associated with the user 102. The identification information may include but not limited to a unique serial number, an email address, a user phone number, a combination of user name and a number, biometric parameter information, bank account information or any other unique identification information. In an example, the RFID tag may be carried by the user 102, such as in a form of a wrist band. In another example, the RFID tag may be implanted within the user 102. The one or more RFID readers detect the RFID tags associated with the user 102 as the user 102 roams from one location to another location and accordingly, the presence of the user 102 may be determined at the different locations.

In an embodiment, the presence of the user 102 at the different locations may be determined using other identification techniques including but not limited to face recognition, voice recognition, retina scan and the other identification techniques. In an embodiment, the location of the user 102 may be provided by the computing device 114 of the user 102. The computing device 114 may be a GPS enable device configured to automatically transmit the location related information to the server 106. The server 106 on receiving such information may update the table 222 and the location tracker log 126.

The table 222 further includes a column 226 that indicates the identified ID of the image capturing device 104 corresponding to the identified location of the user 102 as listed in the column 224. A column 228 indicates timing information regarding the presence of the user 102 at the particular location. The timing information may include date of a day and the durations of the day for which the user 102 is present at the areas covered by the identified image capturing device 104 as listed in the column 226.

Further, a column 230 indicates a storage location of the recorded activities (e.g., recorded videos or images) extracted from the recorded videos or the images of the identified image capturing device 104 for the duration as listed in the column 228. For example, a second row of the table 222 indicates that the user 102 is present at a location “A” on Aug. 12, 2012 during 12:40-12:50. The location “A” is being covered by the image capturing device 104a. Accordingly, the video processing module 112 of the server 106 may be configured to extract video or images captured by the image capturing device 104a during the duration 12:40-12:50. In an example, the video processing module 112 may access the table 212 to access the store 1 which is listed as a pointer to the storage location of the recorded videos or captured images by the image capturing device 104a. The video processing module 112 may apply image processing algorithms to extract the videos or captured images for the duration as listed in the column 228 of the table 222.

In an embodiment, a request may be forwarded to the server 106 for retrieving the recorded videos or images of the user 102 at the different locations. For example, the request for retrieval may be initiated by the user 102 using the retrieve 118 option as described above or it may be initiated by a third party such as a security agency. The request for retrieval may include information such as the user identification, date, timing or location for which the video recording is required. Accordingly, the server 106 may generate the recorded activities as per the user ID and the request for retrieval associated with the user ID.

An exemplary table 232 includes the lists of the users having IDs in a column and a respective storage location for the recorded activities of the users in a column 236. The recorded activities of the user 102 may be generated using the video data as listed in the column 230 of the table 222. The recorded activities thus generated include data in an image, an audio, a video or combination of any of these formats. Further, the recorded activities stored in the database 110 at a location pointed by the column 236 of the table 232 may include any of a JPEG, JPG, BMP, AVG, GIF, WAV or any other multimedia format. In addition, the recorded activities of the user 102 may further be customized according to user's preferences. For example, the recorded activities of the user 102 may be associated with a background sound track as provided in the preference of the user 102.

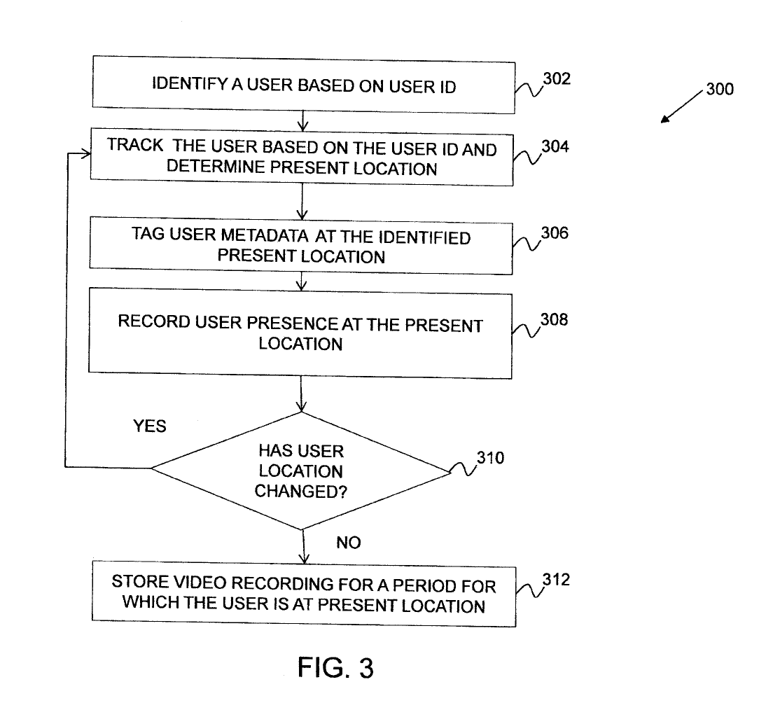

FIG. 3 illustrates an exemplary embodiment of a method 300 for providing location based activity recording of the user in an amusement park. At 302, the user based on a user ID is identified. The user ID may be a unique identification of the user that may be identified as the user enters the amusement park. In an example, the user ID may be an ID stored in an RFID tag carried by the user (as discussed previously). The user ID may be detected by one or more sensors that may be deployed at the different locations in the amusement park. For example, the amusement park entrance may be equipped with RFID tag readers so that the user carrying the RFID tag may be identified as soon as the user enters the amusement park. At 304, the user is tracked based on the identified user ID and the present location of the user is determined. In an embodiment, a plurality of sensors may be deployed throughout the amusement park, so that wherever the user goes, the user is identified based on the user ID and accordingly, the present location of the user is determined. Further, if the a user with ID1 is at location A in the amusement park, where an image capturing device is deployed, and the user falls within the range of the image capturing device, the image capturing device may capture a video of the user with ID1 at the location A. Similarly a plurality of image capturing devices may be deployed at various locations in the amusement park. Each image capturing device may be associated with a unique ID and the plurality of IDs may be configured to cover an entire coverage area within the amusement park and track the user at these locations.

As the user is tracked for movement throughout the amusement park, at 306, user's metadata may be tagged based on the user ID and user's present location. In an example, the user metadata may be stored in a database, such as the database 110. Tagging the metadata of the user in the database 110 may include updating the user information stored in the database 110 based on the user's present location. For example, in the database 110 of FIG. 2, the tagging of the metadata of user with ID1 may include updating the tables 232 and 222 based on user's present location.

At 308, the user presence at the present location may be recorded by the image capturing device, such as the image capturing device 104 illustrated in FIG. 1. Further, as the user moves in the amusement park, at 310, it is determined if the user's present location has changed. If the location has changed, the method returns to 404 to track the user and determine the new location of the user. Otherwise, at 412, the video recording for the user is stored for the period for which the user was at the present location. As long as the user remains within coverage areas of any of the plurality of image capturing devices deployed in the amusement park, associated video recordings of the image capturing devices are stored against the user ID. In an example, the video recording may be further customized, such as by adding a user preferred background score to the video recording. In another example, a user preference may be used for playing back user's preferred music at user's present location, such as in an elevator.

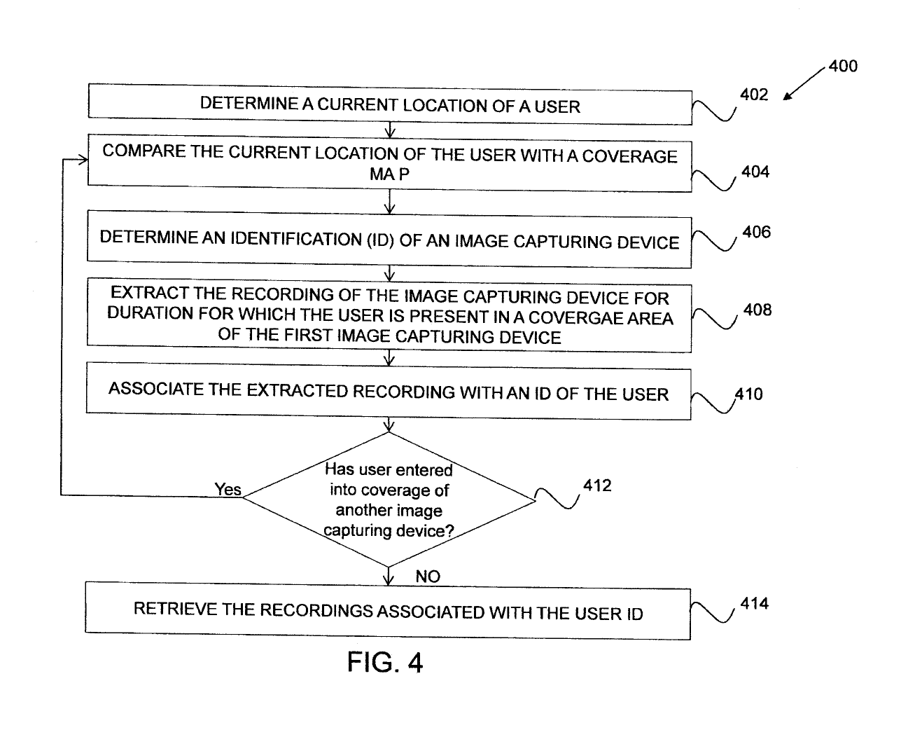

FIG. 4 illustrates an exemplary method 400 for retrieving the recorded activities of the user according to an embodiment of the invention. At 402, a current location of the user is determined. In an example, the current location is determined using one or more sensors mounted at different locations. The one or more sensors detect an identification associated with the user at a current location and accordingly, automatically detect the presence of the user at the current location. In another example, the current location is determined using a device equipped with the GPS or other location determination technologies. At 404, the current location of the user is compared with a coverage map. The coverage map may indicate a geographical area in which activities of the user can be recorded using one or more image capturing devices. The comparison is made to determine the presence of the user in a coverage area of an image capturing device.

At 406, identification (ID) of the image capturing device is determined. For example, the coverage map 128 is used to identify the ID of the image capturing device that can record the activities of the user. At 408, a recording of the image capturing device for duration for which the user is present in the coverage area of the image capturing device is extracted. The extracted recording includes the activities of the user in the coverage area of the image capturing device. At 410, the extracted recording is associated with an ID of the user. At 412, a determination is made as to whether the user has entered into coverage of another image capturing device. The method 400 proceeds to 404 if it is determined that the user has entered into the coverage of another image capturing device. Otherwise, the method 400 proceeds to 414 wherein the recordings associated with the user id are retrieved. Such recordings indicate the activities of the user.

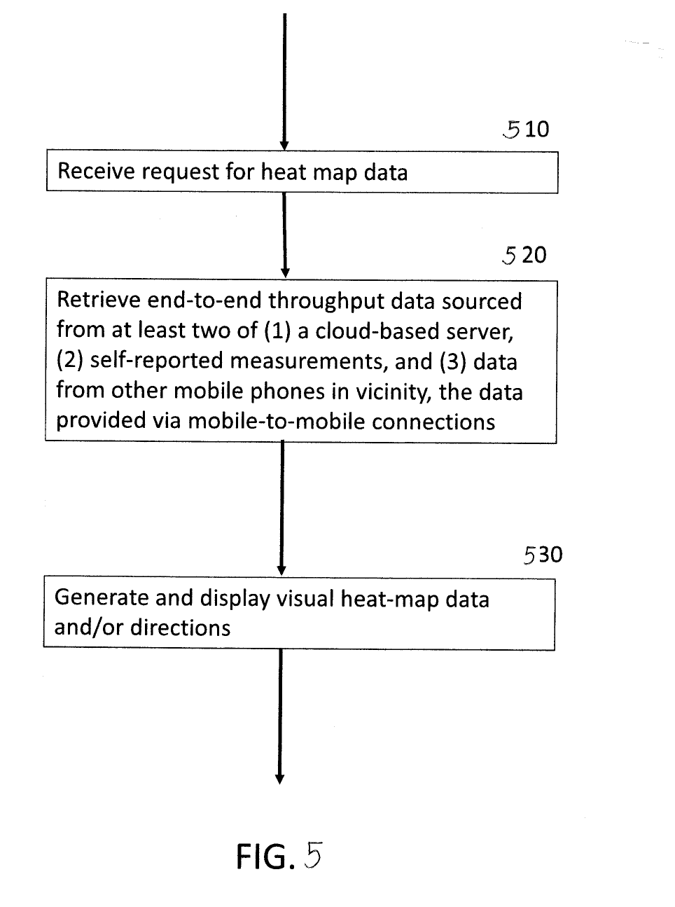

FIG. 5 depicts an illustrative process for generating heat map data for a smartphone from the smartphone's own self-reported measurements of signal strength and data reported directly from other smartphones in the vicinity via mobile-to-mobile communications links in accordance with an embodiment. In arrangements, most or all of functionality of the process 500 is run by software executing on a mobile device, which may be, e.g., a mobile phone (e.g., a smartphone), tablet, navigation system, laptop, portable digital assistant (PDA), or smart watch device. For clarity of presentation only, and not for limitation, it will be assumed in the following description that a mobile device performs the process 500.

At 510, the mobile device receives a request for heat map data. In some arrangements, the request is generated by a human operator of the device while, in other arrangements, the request is auto-generated based on certain event “triggers” detected by a process running in the background of the smartphone.

At 520, the mobile device gathers end-to-end throughput data for locations “in its vicinity.” The gathered data will be used to generate the heat map. For example, if the mobile device is located in an airport terminal, the device gathers end-to-end throughput data for the physical space of the airport terminal (the mobile device is able to realize its physical confines using an indoor mapping service such as those provided by a number of vendors). In some arrangements, the mobile device gathers end-to-end throughput for locations within a certain radius of its current location (e.g., 100 meters of its current location).

In general, the end-to-end throughput data (“throughput data”) sourced by the mobile terminal at 520 is retrieved from at least two of the following sources:

(1) A Remote Server “In The Cloud.” This server stores end-to-end throughput data collected from other mobile terminals in the vicinity of the mobile device (at varying times relative to a current time) and possibly third-party reporting services;
(2) Self-Reported Measurements. These are throughput measurements taken by the mobile device itself, e.g., by periodically sending ping messages to available network access points and assessing an available end-to-end throughput; and
(3) Data Retrieved Directly From Neighboring Devices via Mobile-to-Mobile Connections. This is throughout data provided to the mobile phone from other mobile phones that it has encountered in the vicinity. This data is provided via a mobile-to-mobile connection between the mobile phone and each phone it has so encountered. The mobile-to-mobile connection may be based on a cellular standard (e.g., LTE Direct), WiFi, Bluetooth, or any other suitable mobile-to-mobile communications protocol.

In general, the throughput data retrieved at 520 provides end-to-end throughput data for each of a number of potential access points near to the mobile device. These access points may collectively represent a number of different communications protocols. For example, the access points may variously be based on WiFi protocols, LTE protocols, and CDMA-based protocols. In one arrangement, the mobile phone detects which communications protocols the phone is capable of communicating over and retrieves throughput data only on those particular networks.

The throughput data retrieved by the mobile phone is end-to-end throughput data that measures the specific real-time throughput that is to be expected by a user who connects to that access point. This is in contrast to throughput based on signal amplitudes or a “number of signal bars,” which does not necessarily reflect actual user experience. End-to-end throughout can be calculated according to any suitable technique. For example, in one arrangement, end-to-end throughput is calculated by regularly sending test messages to candidate access points.

At 530, visual heat-map data and/or directions are generated and displayed to a user based on the data retrieved at 520. Visual heat-map data may include a single graphical screen depicting data for each of a number of access points and network types (e.g., WiFi and LTE) or may include separate screens for each network type (e.g., one screen for all WiFi networks and one screen for all LTE networks). The heat map data may take on any suitable form. For example, areas that would potentially provide a user with higher end-to-end throughput may be indicated in one color (e.g., green) while areas with lower end-to-end throughput may be indicated in other colors depending on the throughput level.

Directions to a user may also be presented. Specifically, the mobile phone first makes an assessment of whether the user's throughout can be significantly improved by moving to a nearby location (e.g., by comparing a difference between the maximum achievable throughput and the current throughput to a threshold value). If it is determined that a sufficiently large increase in throughput is possible, then directions to a more desirable location is provided.

Otherwise, no directions are provided to the user. In one arrangement, the visual map and directions (if deemed worthwhile) are overlaid on a single screen. In another arrangement, they are provided on separate screen.

In an embodiment, the retrieved data is stored in a database that indexes throughput values by GPS location, Access Point identifier and type, and, optionally, a time since last update

| | Access | Access | Access | Access |
|---|---|---|---|---|
| | Point 1 | Point 2 | Point 3 | Point 4 |
| Location | (WiFi) | (LTE) | (CDMA) | (WiFi) |
| (x1, y1) | 35.4 kbps/s | 28.4 kbps/s | 4.3 kbps/s | 12.8 kbps/s |
| | (information | (information | (information | (information |
| | received:) | received:) | received:) | received:) |
| (x2, y2) | 12.4 kbps/s | 6.4 kbps/s | 11.3 kbps/s | 19.2 kbps/s |
| | (information | (information | (information | (information |
| | received:) | received:) | received:) | received:) |

The database may periodically purge stale information.

Hereinafter, embodiments of the presently-disclosed systems and methods for providing instructions to a user (e.g., walking or driving directions) to improve the user's connection to one or more access points are described with reference to the accompanying drawings.

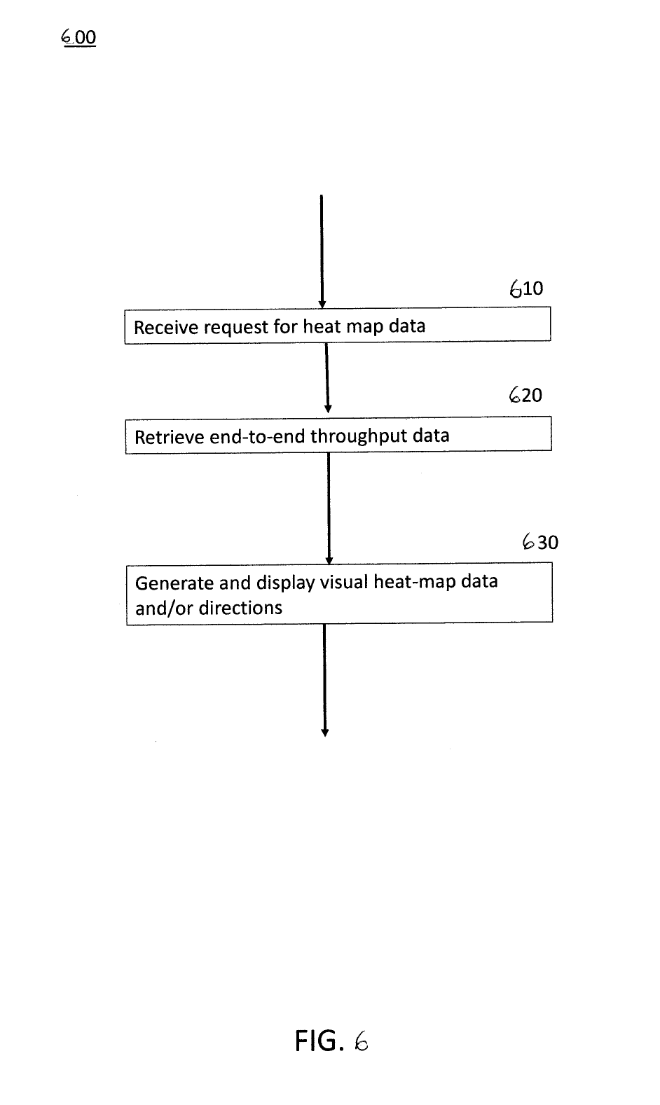

FIG. 6 depicts an illustrative process 600 for generating a signal strength heat map using an omni-directional antenna “mode” in accordance with an embodiment. An omni-directional mode may be executed by a smartphone or other mobile device whether the phone physically houses an omni-directional or directional antenna (or both). The process 600 may be executed on mobile device.

At 610, the mobile device receives a request for heat map data. In one arrangement, the request is generated by a human operator of the device while, in another arrangement, the request is auto-generated based on certain event “triggers” detected by a process running in the background of the smartphone.

At 620, the mobile devices gathers end-to-end throughput data in its vicinity. In one arrangement, if the mobile device is located in an airport terminal (for example), the device gathers end-to-end throughput data for locations within the airport terminal (the mobile phone is able to realize its physical confines using an indoor mapping service such as those provided by a number of vendors). In another arrangement, the mobile device gathers end-to-end throughput for locations within a certain radius of its current location (e.g., 100 meters of its current location).

In general, the end-to-end throughput data (“throughput data”) sourced by the mobile terminal at 620 is retrieved from one or more of the following sources (1) a remote server “in the cloud.” This server stored end-to-end throughput data collected from other mobile terminals running the same process that has recently been in the vicinity and third-party services (2) self-reported measurements by the mobile phone itself, e.g., through repeated sending ping messages to available network access points, and (3) direct mobile-to-mobile data provided to the mobile phone from other mobile phones that it has encountered in the vicinity.

In general, the throughput data retrieved at 620 is retrieved for multiple access points that may cover a number of different communications protocols. For example, data on one or more WiFi networks, LTE networks, and CDMA-based networks. In one arrangement, the mobile phone detects which communications protocols the phone is capable of communicating over and retrieves information only on those particular networks.

The throughput data retrieved by the mobile phone is end-to-end throughput data that measures the specific real-time throughput that is to be expected by a user who connects to that access point. This is in contrast to throughput based on signal amplitudes or a “number of signal bars,” which does not necessarily reflect actual user experience. End-to-end throughout can be calculated according to any suitable technique. For example, in one arrangement, end-to-end throughput is calculated by regularly sending test messages to candidate access points.

At 630, visual heat-map data and/or directions are generated and displayed to a user based on the data retrieved at 620. Visual heat-map data may include a single graphical screen depicting data for each of a number of access points and network types (e.g., WiFi and LTE) or may include separate screens for each network type (e.g., one screen for all WiFi networks and one screen for all LTE networks). The heat map data may take on any suitable form. For example, areas that would potentially provide a user with higher end-to-end throughput may be indicated in one color (e.g., green) while areas with lower end-to-end throughput may be indicated in other colors depending on the throughput level.

Directions to a user may also be presented. Specifically, the mobile phone first makes an assessment of whether the user's throughout can be significantly improved by moving to a nearby location (e.g., by comparing a difference between the maximum achievable throughput and the current throughput to a threshold value). If it is determined that a sufficiently large increase in throughput is possible, then directions to a more desirable location are provided. Otherwise, no directions are provided to the user. In one arrangement, the visual map and directions (if deemed worthwhile) are overlaid on a single screen. In another arrangement, they are provided on separate screen. The directions may be integrated into compass functionality and the user may be provided with a compass that directs him or her to an ideal walking spot.

In an embodiment, the retrieved data is stored in a database that index throughput values by GPS location, Access Point identifier and type, and optionally time since last update:

| | Access | Access | Access | Access |
|---|---|---|---|---|
| | Point 1 | Point 2 | Point 3 | Point 4 |
| Location | (WiFi) | (LTE) | (CDMA) | (WiFi) |
| (x1, y1) | 35.4 kbps/s | 28.4 kbps/s | 4.3 kbps/s | 12.8 kbps/s |
| | (information | (information | (information | (information |
| | received:) | received:) | received:) | received:) |
| (x2, y2) | 12.4 kbps/s | 6.4 kbps/s | 11.3 kbps/s | 19.2 kbps/s |
| | (information | (information | (information | (information |
| | received:) | received:) | received:) | received:) |

The database may periodically purge stale information. Further, in the omni-directional mode, only data from omni-directional antennas is used to generating heatmaps.

Although the technique described above has been described in relation to a omni-directional mode, additional features are available to a user who has a directional antenna, either in place of or additional to a omni-directional antenna on their smartphone. These additional features are described next.

First, in an alternative embodiment, the database may store information on throughputs associated with specific angles with respect to the base station. The database would effectively parse this information by analyzing data produced only by other directional antennas (or so received from third party sources) in its database. In this arrangement, the heat map and instructions provided to the user would be further based on the user's relative orientation in space. For example, in one arrangement, the heat map would dynamically change as a user rotates in place. In one arrangement, the directions provided to a user may simply tell the user to “rotate by 30 degrees in place.”

In may sometimes be the case that the “cost” to a user to use a directional antenna is greater than that to use an omni-directional antenna. The cost may be in terms of battery usage, monetary cost, data usage or any other metric. To account for this case the mobile device provides an option for the user to switch between directional and omni-directional modes.

If desired, the different functions discussed herein may be performed in a different order and/or concurrently with each other. Furthermore, if desired, one or more of the above-described functions may be optional or can be combined. As technology advances, new equipment and techniques can be viable substitutes of the equipment and techniques that have been described in this application.

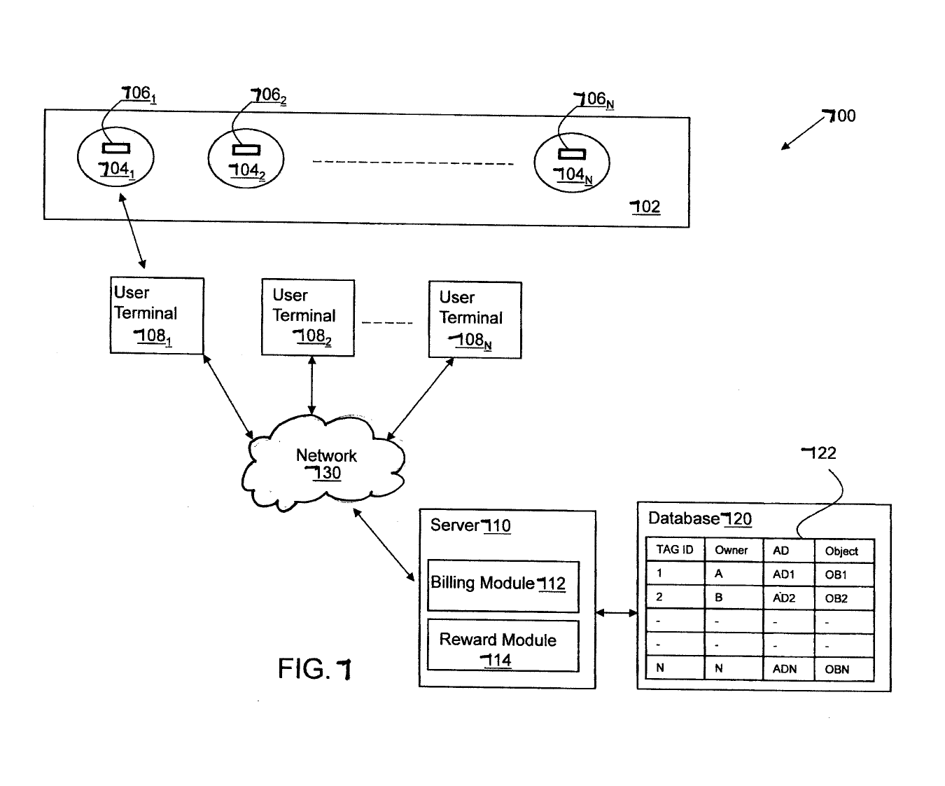

FIG. 7 illustrates an exemplary architecture of a radio frequency identification based (RFID) system 700 configured to deliver an advertisement and reward for delivering the advertisement to the user in accordance with an embodiment of the invention. The system 700 may include a store 702 such as a retail store that may allow the user to access or purchase one or more objects such as an object 704₁, object 704₂ and an object 704_{N}. As illustrated, each object of the one or more objects (referred herein to as the object 704) has a respective RFID tag from one or more RFID tags (referred herein to as the RFID tag 706). For example, a RFID tag 706₁ is affixed to the object 704₁, a RFID tag 706₂ is affixed to the object 704₂ and a RFID tag 706_{N} is affixed to the object 704_{N}.

The objects 704 may include but not limited to a flyer, a banderol on a wall, a magazine, a newspaper, an entrance gate of an event spot such as amusement park, rock concert, cafeteria, restaurant, or any other event spot, consumer goods and any other objects to which the RFID tags 706 can be attached. Further, an ID in the RFID tag 706 can be a human ID implanted on the body or a RFID wrist band that may be worn or carried by a person or any other personal ID that is broadcasted in short/medium range.

The system 700 is configured to include user terminals such as a user terminal 708₁, a user terminal 708₂, and a user terminal 708_{N} referred herein to as the user terminal 708. In an example, the user terminal 708 is a RFID reader that is configured to retrieve information from the RFID tag 706. In an example, the user terminal 708 may be configured to retrieve information from the RFID tag 706 using near field communication protocols. In another example, the user terminal 708 may be configured to establish directional communication with the RFID tag 706 affixed to the object 704. That is to say, the radio waves emitted from the user terminal 708 are directed toward the object 704 and subsequently, information is extracted from the RFID tag 706 affixed to object 704. The user terminal 708 is a network-capable device, such as a computer, a laptop, personal digital assistant (PDA), a mobile telephone, a pager, and any other computing device configurable to communicate with the RFID tag 706.

The system 700 further includes a server 710 that may allow the user terminal 708 to access a database 720 such as for retrieving advertisement related information using the unique ID of the RFID tag 706. In an example, the user terminal 708 may be configured to access the server 710 through a network 730. The network 730 may be a wired or any type of wireless network, including, but not limited to Wi-Fi networks, cell phone networks, as well as any other type of network. Furthermore, network 730 may be associated with any type of network standard including, but not limited to CDMA, TDMA, GSM, AMPS, PCS, analog and/or W-CDMA.

According to one or more embodiments, the RFID tag 706 may be programmed to include the unique ID, information associated with the object 704 and at least a part of advertisement related information. In an example, the RFID tag 706 may be programmed to include the unique ID and the at least a part of the advertisement related information. Such advertisement related information is provided to the user using the user terminal 708 and a reward may be given to an owner of the RFID tag 706 such as an owner of the store 702 when the advertisement is displayed on the user terminal 708.

In one embodiment, the user having an access to the user terminal 708 may approach the object 704 such as for purchasing the object 704 in the store 702. Accordingly, the user terminal 708 is configured to establish a bi-directional link with the RFID tag 706 associated with the object 704. For example, the user terminal 708 may power up the RFID tag 706 and transmits one or more commands such as an extract command to retrieve information stored in the RFID tag 706. In return, the RFID tag 706 may transmit signal including information associated with the unique ID of the RFID tag 706 and any other information stored therein. The information can be related to the object 704 or the advertisement. The user terminal 708 is configured to analyze the transmissions of the RFID tag 706 and accordingly, display information received from the RFID tag 706 on a display panel of the user terminal 708.

In an example, the user terminal 708 is configured to include an application that may process the information received from the RFID tag 706. For example, the application stored in the user terminal 708 may determine processing steps for delivering an advertisement to the user. The information processing may include determination of the unique ID of the RFID tag 706 and extracting an advertisement or information associated with the object 704. In one embodiment, the advertisement or the information associated with the object 704 may be extracted from a local storage of the user terminal 708. In another example, the application may be configured to establish a communication session with the server 710 for extracting the advertisement or information associated with the object 704. Subsequently, the application of the user term7 130. The server 710 is configured to extract the advertisement or the information associated with the object 704 from the database 720.

The database 720 can be any one or a combination of databases such as a hierarchical database, network database, relational database, object-oriented database and the like. In an embodiment, the database 120 includes a table 722 including a list of the unique IDs of the RFID tags 706. Further, the table 722 includes a list of owners corresponding to each tag of the RFID tags 706. The list of owners can be used while delivery of rewards when the advertisement is displayed on the display panel of the user terminal 708. In an example, the server 710 is configured to provide an interface to the owners of the RFID tags to register ownership of the RFID tags 706 with the server 704. The owner of the RFID tags may submit the unique ID of each RFID tag 706 and corresponding information of the object 704 to which RFID tag 706 is affixed during the registration. Further, the server 710 is configured to provide an interface to one or more advertisers for submitting one or more advertisements corresponding to one or more products or services that may be offered by the advertisers. Furthermore, the advertisers may submit one or more requirements for the advertisements so that the advertisements may be mapped to the objects.

In an example, the server 710 may employ one or more mapping algorithms so as to map the advertisements to corresponding IDs of the RFID tags in the table 722 to promote targeted advertising campaigns for the advertisers. Accordingly, the table 722 includes at least one advertisement corresponding to the unique ID of the RFID tag 706. The at least one advertisement may be displayed to the user when the user terminal 708 establishes a communication session with the RFID tag 706 affixed to the object 704. The advertisement may include a brand name and a website of the brand name so that the user may browse the website of the brand name and make a purchase for a particular product or a service that may be offered by the advertiser. In addition, the table 722 further includes information associated with the object 704 corresponding to the unique ID of the RFID tag 706 attached thereto.

In an embodiment, the server 710 may be configured to submit a query to the database 720 for extracting information corresponding to the unique ID of the RFID tag 706. For example, the query may include instructions for the database 720 to extract advertisement associated with the unique ID of the RFID tag 706 affixed to the object 704. In another example, the query may include instructions for the database 720 to extract information associated with the object 704 corresponding to the unique ID of the RFID tag 706 attached thereto. On receiving the advertisement or the information associated with the object 704 of the RFID tag 706, the server 170 may be configured to transmit such information to the user terminal 708. The user terminal 708 receives this information and displays the information on the display panel of the user terminal 708.

In an embodiment, the user terminal 708 notifies the server 170 that the user has viewed the advertisement or the information associated with the object 704 after the user terminal 708 establishes a communication session with the RFID tag 706 affixed to the object 704. The notification to the server 710 may include unique ID of the RFID tag 706, an advertisement ID of the advertisement shown to the user, and information regarding a display view of the advertisement on the display panel of the user terminal 708. The display view of the advertisement may include, but not limited to a header view of the advertisement, picture view, text view, video view including an extent of consumption and any other views.

In an embodiment, the server 710 may be configured to store such notification for each of the advertisement shown to the user so as to bill the respective advertiser. As illustrated in FIG. 7, the server 710 may be configured to include a billing module 712 for generating bills for the respective advertisers whose advertisements are shown to the users. For example, the billing module 712 may utilize the received notifications to determine an amount of billing for a particular advertisement of the advertiser. In addition, the billing module 712 may utilize parameters such as type of the advertisement (e.g., text, audio, video or multimedia), quality of the advertisement (e.g., High definition video or compressed video), timings (peak time or non-peak time), and any other parameters such as to generate billing for the advertisers. Accordingly, the advertiser may pay the billed amount such as to deliver advertisements using RFID tags.

In an embodiment, the server 710 is configured to reward the owners of the RFID tags 706 so that the owners receive economical benefits for registering the RFID tags 706 with the system 700. As illustrated in FIG. 7, the server 710 includes a reward module 714 for determining the reward for the owner of the RFID tag 706. In an example, the owner may be provided a specific share of the billed amount corresponding to a specific RFID tag 706, when the advertisement corresponding to the specific RFID tag 706 is shown to the user. The reward may include monetary benefits to the owner of the RFID tag 706. In another example, the reward may include listing of the specific owner as a trusted owner, providing sponsored owner status for a predetermined period, and other awards that may increase selection probability of the RFID tags of the specific owner by the advertisers.

In one embodiment, the reward module 714 may be configured to share the reward for displaying the advertisement on the user terminal 708 among the owner of the RFID tag 706 and one or more users. For example, a user of the user terminal 708₁ may determine that a particular advertisement shown on establishment of a communication session between the RFID tag 706₁ and the user terminal 708₁ is suitable for other users also. Accordingly, the particular advertisement is shared with the user terminal 708₂. For example, the particular advertisement may be shared with other user terminals on internet or intranet through social applications, websites or any other websites that may be accessible to the user terminal 708. In addition, the user terminal 708₁ shares the unique ID of the RFID tag 706₁ and user identification (ID) while sharing the advertisement with another user terminal 708₂. Subsequently, the unique ID of the RFID tag 706₁ and the ID of the user of the user terminal 708₁ is transmitted to the server 710, when the user terminal 708₂ accesses the shared advertisement from the server 170. Accordingly, reward module 114 shares the reward among the owner of the RFID tag 706₁ and the user of the user terminal 708₁. Such sharing of rewards among the owners of the RFID tags and one or more users creates multi level hierarchy for an advertisement revenue sharing model.

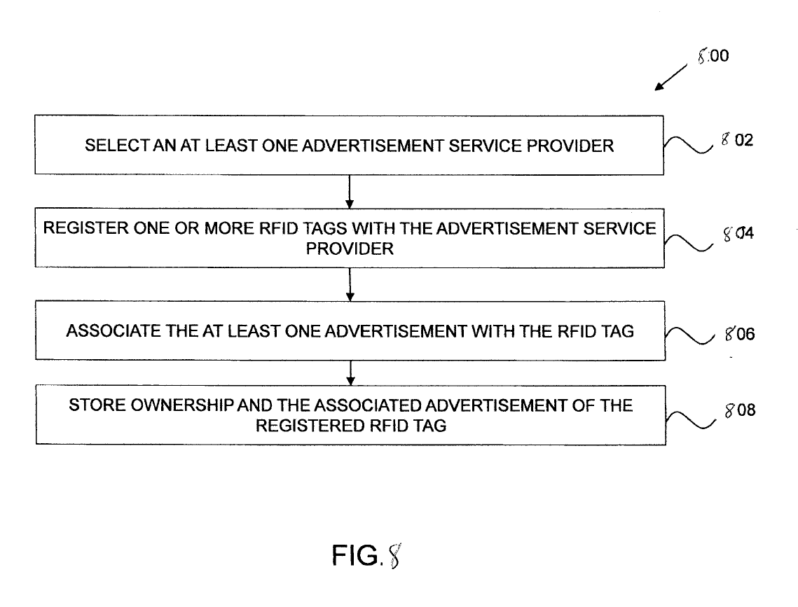

FIG. 8 illustrates an exemplary method 800 for storing an ownership of a RFID tag according to an embodiment of the invention. The method 800 allows the owners of the RFID tags to register the RFID tags with an advertisement service provider so that the advertisement service provider associates an advertisement with the respective registered RFID tags. The method 800 initiates at 802 wherein at least one advertisement service provider is selected. For example, the owner of the RFID tag may select the advertisement service provider depending on the rewards or monetary benefits shared by the advertisement service provider among the users and owners of the RFID tags. At 804, one or more RFID tags are registered with the advertisement service provider. The owner may register RFID tags depending on the objects on which these tags will be affixed. At 806, at least one advertisement is associated with the RFID tag. For example, the advertisement service provider may employ one or more mapping algorithms so as to map the at least one advertisement from the advertisers with the registered RFID tags. At 808, ownership and the associated advertisement of the registered RFID tag is stored such as in a database. As discussed above, the database may be accessed by the user terminal to retrieve the advertisement associated with the RFID tag affixed to the object.

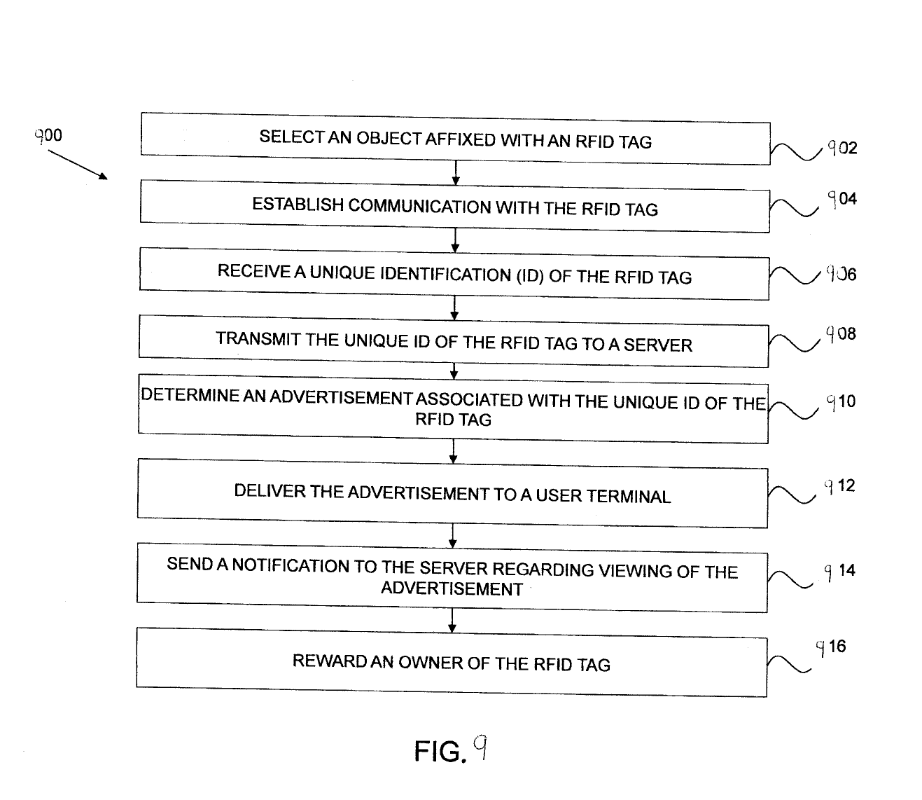

FIG. 9 illustrates an exemplary method 900 for providing rewards to an owner of the RFID tag on delivery of an advertisement to a user, according to an embodiment of the invention. The method 900 enables provisioning of revenue sharing model wherein the owners of the RFID tags are encouraged to deliver advertisements using RFID tags. At 902, an object affixed with an RFID tag is selected. For example, a user may access a user terminal such as the user terminal 708 to select the object 704 for extracting information associated with the RFID tag 706. At 904, communication is established with the RFID tag. In an example, the user terminal 708 establishes the communication with the RFID tag 706 affixed to the object 704 using technologies such as NFC, directional communication and the like. At 906, a unique identification (ID) of the RFID tag is received. For example, the user terminal 708 establishes a communication session with the RFID tag 706 and retrieves the unique ID of the RFID tag 706. At 908, the unique ID of the RFID tag is transmitted to a server such as the advertisement service provider.

The method 900 proceeds to 910 wherein an advertisement associated with the unique ID of the RFID tag is determined. In an example, the server may submit a query to a database such as the database 720 to retrieve information available in a table stored in the database. The table includes a list of registered RFID tags mapped to one or more advertisements that may be submitted by the advertisers. At 912, the advertisement thus determined is delivered to a user terminal. At 914, a notification is sent to the server regarding viewing of the advertisement. For example, the user terminal 708 may transmit this notification to the server when the advertisement is displayed to the user on a display panel of the user terminal. At 916, owner of the RFID tag is rewarded. The reward may ensure that the owners receive at least a portion of the revenue generated by the advertisement service provider and thereby, may act as an encouragement means for the owner of the RFID tags.

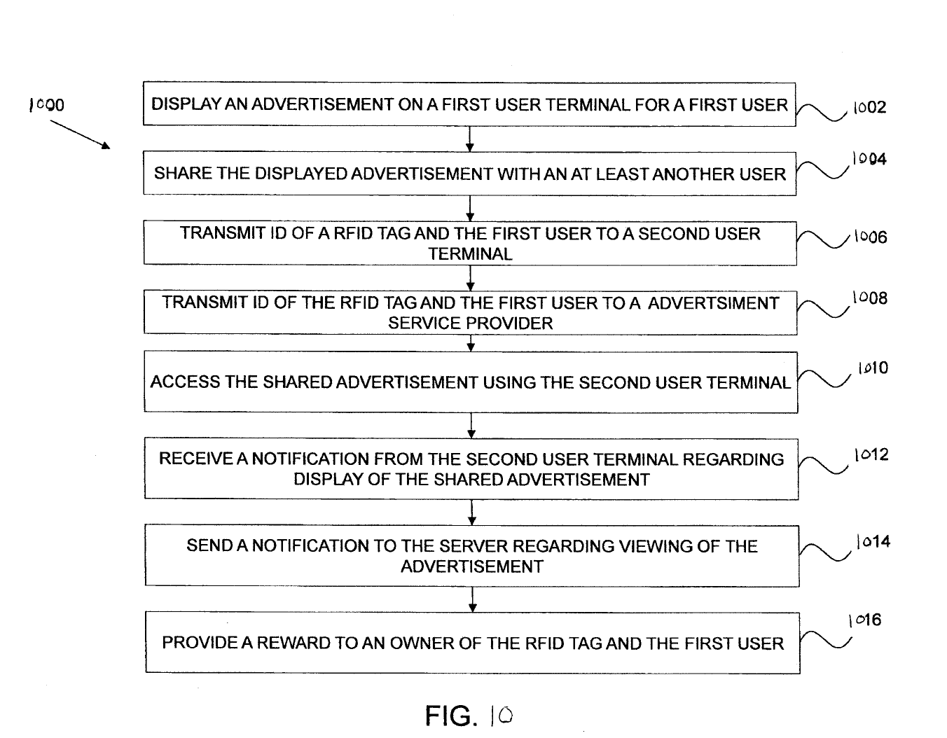

FIG. 10 illustrates an exemplary method 1000 for sharing the rewards among the owners of the RFID tags and at least one user. The method 1000 may encourage the users to share the advertisement received on communicating with the RFID tag affixed to the object. At 1002, an advertisement is displayed on a first user terminal for a first user. Such display of the advertisement may generate reward for the owner of the RFID tag as discussed at 914 and 916 of the method 900. The first user may be interested in sharing the displayed advertisement to another user and at 1004, the displayed advertisement is shared with an at least another user. For example, the displayed advertisement may be shared from first user terminal such as the user terminal 708₁ to a second user terminal such as user terminal 708₂. At 1006, identification information of the RFID tag (e.g., unique ID of the RFID tag) and the first user who shared the displayed advertisement is transmitted to the second user terminal. At 1008, identification information of the RFID tag (e.g., unique ID of the RFID tag) and the first user who shared the displayed advertisement is transmitted to an advertisement service provider. At 410, the shared advertisement is accessed using the second user terminal. In an example, the shared advertisement may be accessed using steps 908, 910 and 912 of the method 900. At 1012, a notification is received from the second user terminal regarding display of the shared advertisement on the second user terminal. At 1014, a reward is provided to an owner of RFID tag and the first user who has shared the advertisement with the second user terminal.

The present invention relates to exemplary embodiments of methods, systems and computer program products related to a smart mailbox for providing enhanced services and functions related to courier or correspondence delivery. The smart mailbox of the exemplary embodiments described herein includes RFID and other sensory capabilities, such as barcode and/or QR code reading, optical character recognition (OCR) technology, video cameras, temperature sensors, LED based sensors and the like. The RFID and other sensory capabilities of the mailbox help in providing enhanced functionalities and services such as courier identification, courier notifications, alerts for pending couriers, courier receipt confirmation, enhanced security while receiving hand delivered couriers, and courier sorting and categorizing based on sender, addressee, urgency and the like. For example, the video camera of the smart mailbox may help to identify who is delivering the courier at the smart mailbox or who is trying to access the smart mailbox. This video may then be sent from the smart mailbox to the mailbox owner to provide enhanced tracking service. These and other capabilities of the smart mailbox will be discussed in the description below.

The methods, systems and computer program products of the exemplary embodiments also include a unique ID equipped courier. It is appreciated that as described herein, “courier” refers to any letter, mail, parcel, package or envelope currently used by carriers such as the post office. Additionally, “mailbox” refers to a physical drop box for couriers.

The methods, systems and computer program products of the exemplary embodiments may also include that the unique ID be provided to a postman delivering the courier such as, by attaching an RFID tag containing the unique ID stored therein to the postman's vest or vehicle.

As will be discussed throughout the invention description, the term “mailbox owner” could mean a residential or a corporate mailbox owner. Description of first embodiment and first figure

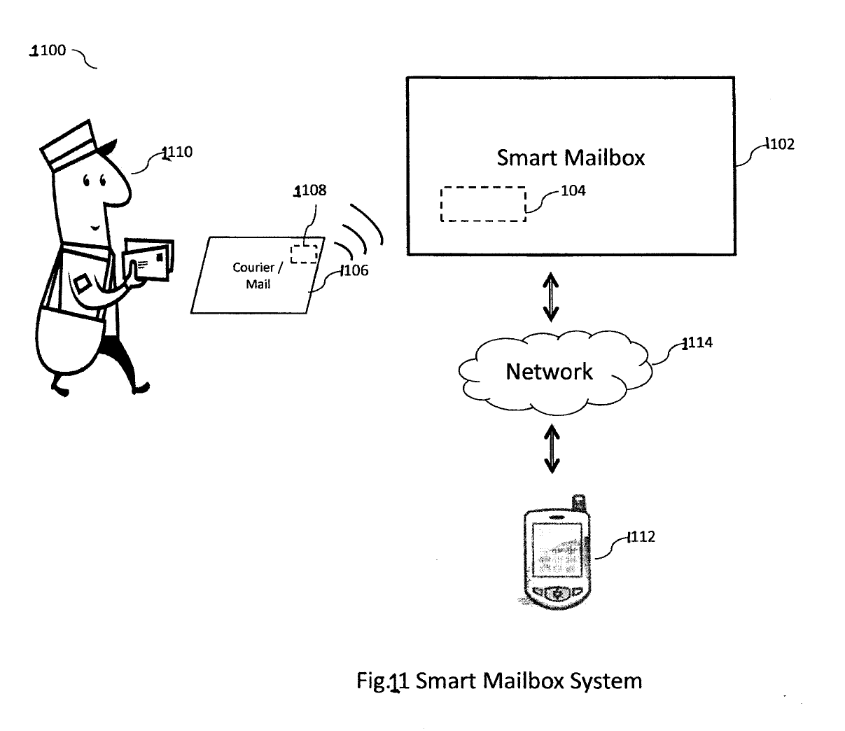

FIG. 11 illustrates an exemplary embodiment of a smart mailbox system 1100. The smart mailbox system 1100 includes the smart mailbox 1102 equipped with at least one RFID sensor 1104, a correspondence or courier 1106 including an RFID tag 1108 being delivered by a postman 1110. The system 1100 may further include a communication device 1112 configured to establish communication with the smart mailbox 1102 over a network 1114.

In the exemplary embodiment of FIG. 11, the RFID sensor 1104 can be an RFID tag reader. In other exemplary embodiments, other sensors could be used in isolation or in combination with the RFID sensor 1104. The other sensors could include a barcode reader, an OCR system, an optical scanner, an LED detector, a video camera, a laser sensor etc. Each of these sensors may be used to exchange courier related information with the smart mailbox 1102. For example, the barcode reader may be configured to read a barcode printed on the courier 1106. The video camera may be configured to retrieve an image or a complete video of the courier 1106 along with the postman 1110 delivering the courier. Similarly, the RFID sensor 1104 may be configured to detect a unique ID associated with the courier 1106.

For example, when the postman 1110 carrying the courier 1106 equipped with RFID tag 1108 comes in the vicinity of the smart mailbox 1102, the RFID sensor 1104 of the smart mailbox sends an interrogation signal to the RFID tag 1108. As a result of this, electromagnetic coupling is formed between the RFID tag 1108 and the RFID sensor 1104. Through this coupling, the RFID tag 108 sends an ID, such as the unique ID of the courier, to the RFID sensor 1104, which can then be used to uniquely identify the courier 1106. Thus, the RFID sensor 1104 is configured to detect transmissions from the RFID tag 1108 attached to the courier 1106. The RFID tag 1108 may be a passive RFID tag or an active RFID tag. Passive RFID tags work without a battery and are powered by energy from an interrogating electromagnetic field (of the tag reader). Active RFID tags on the other hand are powered by an internal power source (or battery) thereby remaining continuously powered and may operate at a distance of hundreds of meters.

In an example, the RFID tag 1108 includes courier information electronically stored on it. In an example, the courier information may include the unique ID of the courier 1106 to uniquely identify the courier being delivered to the smart mailbox 1102. For example, the courier 1106 may contain an RFID tag 1108 attached to it, which may store the unique ID corresponding to the courier. In an example, a list or collection of unique IDs corresponding to different couriers may be maintained in a database. The database may be maintained by a mail carrier, such as the post office. The unique ID may be identified by the RFID sensor 1104 of the smart mailbox to enable the smart mail box to provide the plurality of enhanced services to a mailbox owner.

In an example, the RFID tag 1108 may be attached to the postman 1110, such as to the postman's 1110 vest or vehicle. In this example, the unique ID may be used to identify the postman who delivered the courier 106 at the smart mailbox 1102.

In an example, the unique ID contained in the RFID tag 1108 may be broadcast to the smart mailbox 1102 as the postman 1110 delivers the courier 1106 to the smart mailbox 1102. The RFID sensor 1104 of the smart mailbox 1102 may detect the unique ID being broadcast or transmitted by the RFID tag 1108 and use it to uniquely identify the courier 1106.

The RFID tag 1108 may also contain other courier information apart from the unique ID of the courier 1106. Such information may include one or more of sender information, an addressee information, urgency information, and mail categorization such as bills, school correspondence, bank statements and the like. In an example, the courier information may be stored in the RFID tag 1108 attached to the courier 1106 by the courier service provider, such as the post office system. In an alternate example, the courier information may be provided by the source of the courier 1106, at the time of submitting the courier for delivery to the courier carrier.

In an example, the courier information may be used by the smart mailbox 1102 to automatically identify and sort the couriers received in the smart mailbox 1102. This information may then be identified by the smart mailbox's RFID sensor 1104 and sent to the remote communication device 1112 over the network 1114. The remote communication device 1112 may correspond to the owner of the smart mailbox 1102. For example, the remote communication device 1112 may be a Smartphone belonging to the mailbox owner. The mailbox owner may access the courier information using a Smartphone application. The application may be provided to the mailbox owner as a free application or the mailbox owner may be required to pay a monthly fee for accessing the application. In an example, access of the courier information using the application may enable tracking of types of couriers received by the mailbox owner. This information may further enable sending of targeted advertisements to the mailbox owner's communication device 1112 over the network 1114. For example, the mailbox owner may receive bank statements in the smart mailbox 1102 from a bank A. As the mailbox owner accesses the courier information about the couriers received from bank A using the application, such as from their Smartphone, the mailbox owner's browsing and accessing of the application and associated content (such as courier information about courier from bank A) may be tracked over the network 1114. Further, this information may then be sent to bank A which may send a targeted advertisement about existing loan options available for customers of bank A to the mailbox owner's Smartphone. In a similar manner, tracking of mailbox owner's application access over the network 1114 may be used by other service providers, such as restaurants, retail stores, insurance agencies and the like to send targeted advertisements to the mailbox owner over the network 1114. The network 1114 may include any of an Internet, a Wi-Fi network, a cellular network, or a cognitive radio (CR) network etc.

In an example, the targeted advertisements may be used by the courier service provider to generate revenue for their business. In this manner, the smart mailbox 102 may not only facilitate the mailbox owners, but also the courier service providers. However, the application may also facilitate selective targeted advertisement blocking on the basis of mailbox owner's preference. For this, the application may be configured to access user's preference which may be stored in a database maintained in the network 1112.

In an example, the application may be used to provide an indication to the mailbox owner if anyone tampers with his/her mail box. For example, the smart mailbox 1102 may be equipped with RFID and other sensors, such as a motion sensor that may sense any activity at the mailbox. In an example, the motion sensor may sense an attempt to open the smart mailbox 1102 by sensing the motion of a gate of the smart mailbox. If an attempt to open the smart mailbox 1102, as detected by the motion sensor, does not lead to opening of the smart mailbox 1102, an alert may be sent from the smart mailbox 1102 to the mailbox owner's Smartphone. The alert may signal to the mailbox owner that an attempt to open the smart mailbox 1102 may have been made.

In an example, the smart mailbox 1102 may be used for providing personalized notifications to a plurality of mailbox owners. For example, a household may have different mail recipients sharing a common mail box. The smart mailbox 1102 may be configured to send personalized notifications to each of the mail recipients associated with the smart mailbox 1102, based on the received courier information. In this example, each of the mail recipients may be associated with a separate communication device. Each communication device may in turn be associated with a unique identifier, such as a mobile number. When the postman 1110 delivers the courier 1106 in the smart mailbox 1102, the RFID sensor 1104 and a scanner of the smart mailbox 1102 may identify courier information associated with the courier 1106, based on the RFID tag 108 attached to the courier. This information may include information about the intended mail recipient, type of mail, purpose of the received mail and the like. Based on the identified recipient, the smart mailbox 1102 may compare the intended mail recipient information with the list of mail recipients associated with the smart mailbox 1102. Further, the smart mailbox 1102 may then proceed to send a notification of the receipt of the courier to the mobile number associated with the identified mail recipient.

In an example, the processing of the courier information may be performed by a computing component that may be remote from the smart mailbox 1102. In an alternate example, the processing of the courier information may be performed by a computing component that may be included within the smart mailbox 1102.

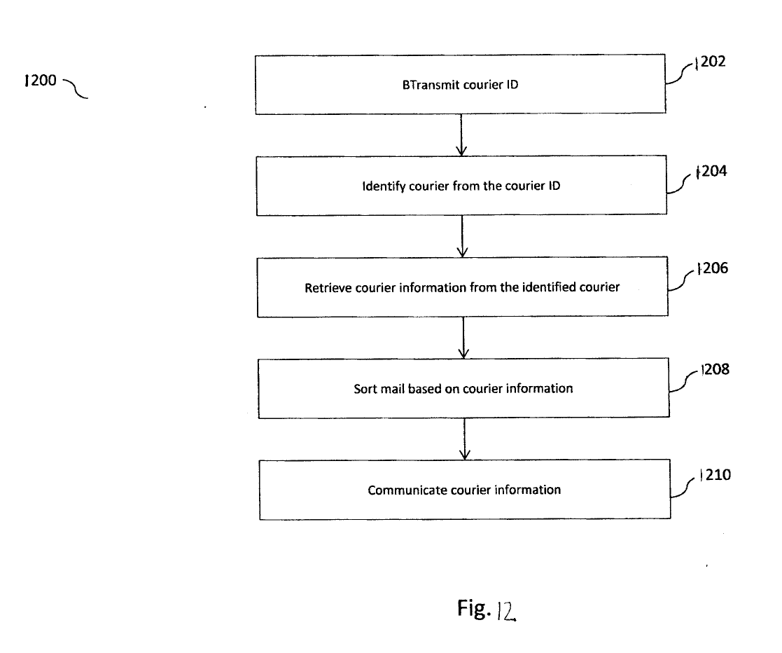

FIG. 12 illustrates an exemplary embodiment of a method of using the smart mailbox system of the present invention. The method 1200 begins when a postman delivering a courier is in the vicinity of the smart mailbox, like when a postman approaches the smart mailbox for courier delivery. The courier may be equipped with a courier ID, such as the unique ID stored in the RFID tag 1108 of FIG. 11. At 1202, the courier's ID is transmitted to the smart mailbox. In an example, the transmission may be initiated by broadcasting the courier ID from the RFID tag attached to the courier. The transmission from the RFID tag may then be detected by the RFID sensor of the smart mailbox. Once, the transmission is detected by the RFID sensor of the smart mailbox, at 1204 the courier is identified on the basis of the courier ID. The identification may be performed by reading the courier ID, which may be a unique serial number, from the RFID tag of courier.

Once the courier is identified, at 1206, courier information stored on the RFID tag attached to the courier is retrieved. In an example, the courier information may include information related to one or more of a sender, an addressee, urgency of mail, type of mail such as bill or bank statement or school/college correspondence and the like.

In an example, the courier information may include authorization related information to identify if the courier associated with the identified courier ID is allowed to access the smart mailbox for courier delivery. If the courier associated with the courier ID is authenticated, the smart mailbox may unlock itself and allow the postman to access the smart mailbox. Alternatively, upon authentication, the smart mailbox may send an authorization response to the postman to proceed to deliver the courier. In an example, the authorization response may include a confirmation of delivery address and name recipients details authorized to receive the mail and packages at the specified address. The authorization of the courier for delivery may then lead to the smart mailbox performing other enhanced services based on the retrieved courier information.

In the exemplary embodiment of FIG. 12, once the courier information has been retrieved, the method proceeds to 1208, where the smart mailbox provides the enhanced service of sorting the mail based on the retrieved courier information. In an example, the smart mailbox may be equipped with other sensory capabilities that may assist in sorting the mail. Other sensory capabilities associated with the smart mailbox may include, but may not be limited to, an optical scanner, an OCR system, a barcode scanner, a QR code reader and the like. For example, information about the mail sender and urgency of mail may be embedded in the form of a QR code imprinted on the courier. A QR code reader of the smart mailbox may read this information and identify the mail as a “High Priority Mail”. The smart mailbox may then send a notification to the mailbox owner indicating that a high priority mail has been received at the smart mailbox. Alternatively, the smart mailbox may include a mechanical arrangement for placing the high priority mail in a specific section within the smart mailbox.

Further, at 1210, the retrieved courier information may be communicated for providing enhanced mailbox services. In an example, the retrieved courier information may be communicated to a remote communication device, such as a Smartphone, a tablet, a PDA and the like via a remote network.

In an example, the courier information may be retrieved on the basis of a courier ID that may be stored in an RFID tag attached to the postman delivering the mail.

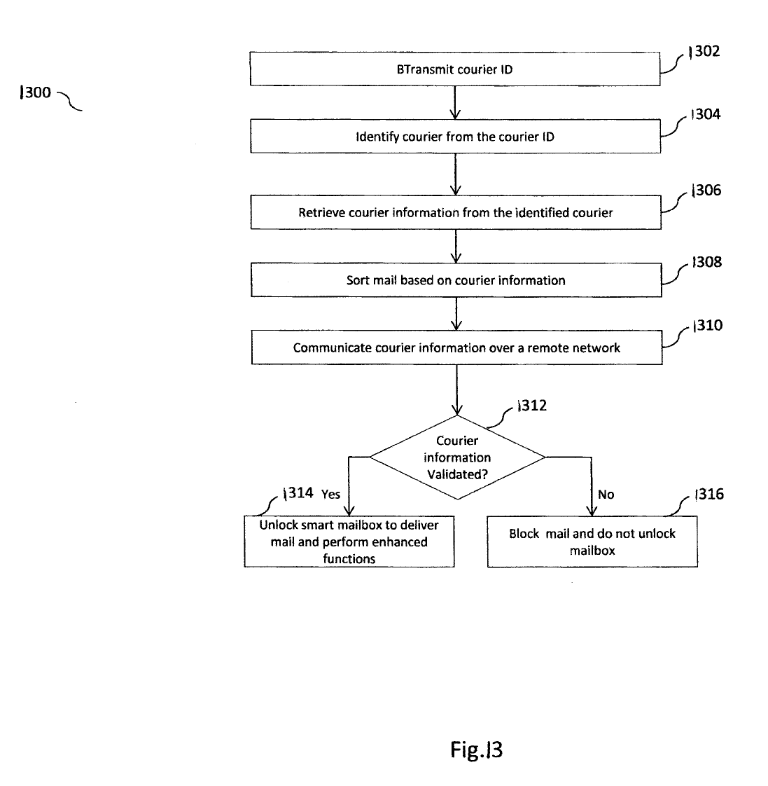

FIG. 13 illustrates an example of a method for using a smart mailbox using courier validation, according to an embodiment of the invention.

The method steps 1302-1308 of FIG. 13 include all the method steps discussed in conjunction with FIG. 12, as previously discussed. In addition, FIG. 13 illustrates, at 1310, communicating the courier information over a remote network. The remote network may include, but may not be limited to the mailbox owner's home Wi-Fi network, the courier service provider's network, the Internet, a cellular network, or a cognitive radio (CR) network. In an example, the courier information may be communicated over the remote network to a computing component that may utilize the courier information for performing enhanced services, such as sending personalized notifications to different mail recipients, confirming mail receipt for intended mail senders, blocking/unblocking receipt of mails from specific senders and the like. For example, upon delivery of a mail, the smart mailbox sensors may scan the received mail, and compare the received mail with what the postman intended to deliver. Further, the mail box sensors may provide an electronic receipt for those mail senders that may have requested such a delivery. For example, credit card holders may want to receive a confirmation that new credit cards have been delivered to proper address and are currently waiting for customer's activation call. The provision of these and other enhanced services may require that the courier information sent over the remote network may first be validated at 1312.

During validation, a sender related information may be sent over the remote network, such as to a computing device such as the mailbox owner's Smartphone. This computing device may then validate the sender on the basis of mailbox owner's preference for receiving couriers from this particular sender. For example, a mailbox owner may not prefer to receive mails from a list of senders, such as certain advertisers, real estate agents or bank promotional offers. The courier information may include information related to sender of the courier. The mailbox owner's preferences for senders may be stored in a database maintained over the remote network. In an example, the information about the couriers to be blocked may be stored in an internet database, such as a “Do Not Mail” database. If the sender is validated, at 1314, the courier may be delivered in the smart mailbox by unlocking the smart mailbox. Else, at 1316, the courier may be blocked from delivery by not allowing the smart mailbox to open. In an example, the smart mailbox's RFID may inform the postman delivering the courier of the undesirability of a particular courier. In addition, the smart mailbox may provide a list of senders to be blocked.

In an example, the validation of the courier information may further include indicating to the postman that the smart mail box owner has left a courier to be picked up or returned to the postman.

In an example, validation of the courier information may include validating the courier based on the identity of the person opening the smart mailbox. For example, the courier information may indicate an identity of the person opening the smart mailbox, such as a family member, a regular postman, a postman deputy, certain advertisers and the like.

In an example, the identity of the person opening the smart mailbox may be linked to information about the courier, such as the contents of the courier. This information about the courier may be either provided by the person opening the smart mailbox, or may be retrieved from the courier ID. The identity information linked to courier information may then be sent to the mailbox owner over the internet. The mailbox owner may then validate the information.

In an example, the smart mailbox may be linked to the Internet, such that the validation may be performed over the Internet. For example the courier information may be delivered to an application or to a defined email address over the Internet. The courier information may relate to certain bills and time sensitive mails. In this example, the information about the time sensitive mails may be added to a calendar of the mailbox owner, such as to an email calendar application, with an appropriate reminder. In an example, the calendar may be associated with a defined email address. The reminders may be provided to the mailbox owner, when the mailbox owner accesses the defined email address. In an example, such an access may take place over the mailbox owner's Smartphone.

In this manner, the smart mailbox of the present invention may provide a number of enhanced services over the traditional physical mailboxes. Such enhanced features have been discussed throughout the invention. Some of these features include tracking of mail delivery, selective mail blocking, providing personalized mail delivery notifications, real-time mail receipt acknowledgement and the like. These other features of the invention may benefit not only the courier system providers, such as the US post system, but also the household and corporate mailbox owners. The benefits may include, timely mail delivery, better customer service, mail loss avoidance, avoidance of delays, prioritization of urgent mails and the like.

It may be understood that embodiments discussed in the present invention are for exemplary purpose and not to limit the scope of the invention. The methods and apparatus discussed in the invention may also be used in other examples apart from courier delivery, such as newspaper delivery, letter delivery, gift item delivery and the like.

Hereinafter, embodiments of the presently-disclosed network-based techniques for the rental and lease of products using human ID are described with reference to the accompanying drawings. Like reference numerals may refer to similar or identical elements throughout the description of the figures.

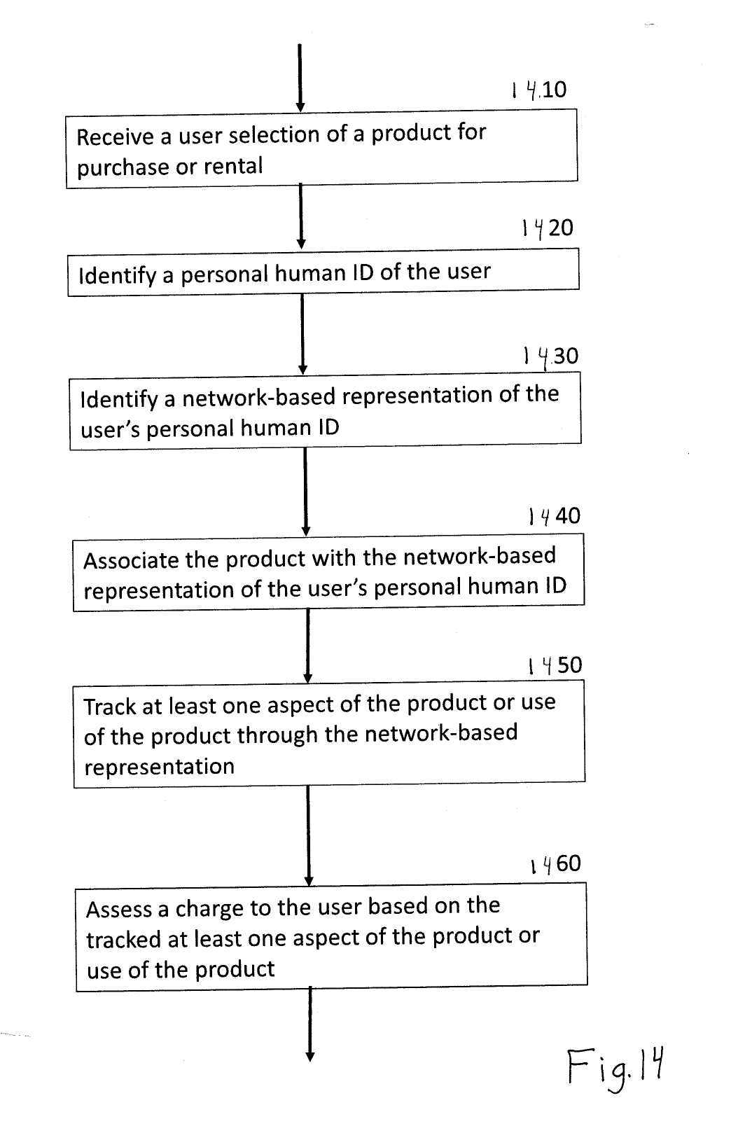

FIG. 14 depicts an illustrative network-based process for renting or leasing products to a user based on human ID in accordance with an embodiment. In arrangements, some or all of the functions of the process 1400 are executed by a computer system owned and/or operator by a rental or leasing agency in combination with a server running software, the server located remotely from the computing system (the computing system and server running software will be referred to collectively as “the network computing system”). For clarity of presentation only and not for the purposes of limitation, it will be assumed below that the network computing system performs certain functions of the process 1400, as described below.

At 1410, a user selection of a product for purchase or rental is received. The selection may be for any time of product that is commonly renting. As some specific example, the product may be a computer, computer accessory, furniture, lighting, televisions, and commercial equipment such as tools or construction equipment. In addition, the request may be received in person, when the user visits a store. In that case, the user may indicate his or her selection to a customer service representative of the store or may specify his or her request using electronic means (e.g., by entering purchase selection in a computer or automated vending machine).

Alternatively, the user may provide a selection to the network computer system via the Internet or through other computing means. In this case, the user may have the rented or leased product mailed to him or her or may pick-up the product from a commercial site at a later time.

At 1420, a personal human ID of the user is identified. The human ID is a chip (e.g., a passive or active RFID tag), the data of which provides an identity of the user. The human ID is generally a semi-permanent user identifier and, as contemplated herein, may be embedded or else physical attached to a user in a way that makes a causal transfer of the human ID from one user to another difficult or impossible. For example, in some arrangements, circuitry of the human ID embedded underneath of the skin of a user, while in other embodiments, the human ID is perhaps readily visible but fused to the body of the user and includes tamper protection which disables the human ID circuitry in case an attempt is made to remove the circuitry from its intended owner. The personal human ID of the user may be identified when the user enters a commercial facility of the company as part of a one-time initial registration process and agrees to have their personal human ID read by a RFID or other wireless scanner.

In some arrangements, the human ID circuitry of a user stores a general code that is not immediately recognized by the network computing system.

In these embodiments, the user must first register his human ID with the network computing system. In other words, in these embodiments, the network computing system maps an individual's human ID code to a company-specific user account.

This provides a layer of safety and security for the user as a majority of transactional documentation related to the user's business with the company may specify the user's company-specific account number rather than the user's globally-existent human ID code.

At 1430, a network-based representation of the user's personal human ID identified. In particular, upon receiving the identity of the personal human ID of the user at 1420, the network computing system performs a lookup to determine a company-specific account no associated with the human ID. The lookup may be performed when a local server of the company contacts a remote server (which may also be owned and/or operated by the company) to perform the lookup.

Alternatively, the company's computing system may contact a remote and trusted third-party database to perform the lookup function. In some embodiments, once the company determines an existing company-specific account number for the user, the company's computing system use only that information and effectively disregard (e.g., delete) the personal human ID value received at 130 from any current transactional efforts. On the other hand, if the user has never before established a company-specific account number, then, in some arrangements, the user is guided through a process for establishing an account. As part of the registration process, the company may store a mapping between the user's human ID received at 1420 and the newly-established company-specific account number, either at a local or at a remote server to the transaction. The company-specific account number for a user is the network-based representation of the user's personal human ID.

At 1440, the product that is to be rented or leased is associated with the network-based representation of the user's personal human ID, i.e., the company specific account number. In particular, a database is updated to associate the product with the company-specific ID number. Similarly, if a user rents or leases multiple products, all of those products are associated with the user's company-specific account no.

At 1450, at least one aspect of the product or use of the product is tracked through the network based representation. In arrangements, the rented or leased product carries a transmitter that communicates usage information back to a company server. Usage information may include one or more of mileage (in the case of, e.g., rented bicycles or kayaks), total tonnage lifted (e.g., in the case of construction equipment), and hours of usage (e.g., in the case of computers are related accessories). This and other types of information are monitored by circuited implanted onto the device by the company and periodically reported back to the company. In some arrangements, the device continually reports back its location, e.g., by reporting back a GPS location. In arrangements, the device may transmit information back to a company server using at least one of a cellular signal, WiFi signal, and a Bluetooth signal.

This information that is reported back to the company (and more accurately, a company server) allows the company to not only generally track the device, but also to determine whether the device breaks or somehow malfunctions (e.g., this may be inferred if the device stops producing reporting information) and log a degree of usage of the device by the user who rents or leases it.

At 1460, a charge is assessed to the user based on the tracked at least one aspect of the product. For example, in arrangements, the company charges a flat fee for the rental or lease of a product plus a variable “usage fee” which depends on a degree of usage of the device. Additionally, if the device is determined to be damaged and in need of repair, the company automatically debits the user from payment information (e.g., credit card information) that is stored in connection with the user's company-specific account number in a database. Finally, if the user never returns the product, or if it is determined, that the product has “disappeared” or broken, and if the user does not provide a suitable explanation, then the user is automatically debited for the effective destruction of the product from the payment information that is stored in connection with the user's company-specific account number in the database.

Thus, what is described in this disclosure are, inter alia, network based techniques for facilitating an all-electronic and fully user-accountable rental and leasing system. Based on the disclosed techniques, users may no longer need to purchase many common household and office items. Rather, given the ease of use (i.e., given the all-electronic method described) and fairness of the charges (i.e., based on actual usage rather than pure flat fee), users will be significantly more likely to rent or lease products using human ID based techniques.

Embodiments of the present invention may be implemented in software, hardware, application logic or a combination of software, hardware and application logic. The software, application logic and/or hardware may reside on mobile computer equipment, fixed equipment or servers that may not always be owned or operated by a single entity.

If desired, part of the software, application logic and/or hardware may reside on multiple servers and equipment in charge of different processes.

In an example embodiment, the application logic, software or an instruction set is maintained on any one of various conventional computer-readable media. In the context of this application, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a fixed or mobile computer.

If desired, the different functions discussed herein may be performed in a different order and/or concurrently with each other. Furthermore, if desired, one or more of the above-described functions may be optional or can be combined. As technology advances, new equipment and techniques can be viable substitutes of the equipment and techniques that have been described in this application.

Although various aspects of the invention are set out in the independent claims, other aspects of the invention comprise other combinations of features from the described embodiments and/or the dependent claims with the features of the independent claims, and not solely the combinations explicitly set out in the claims. The above described example embodiments of the invention should not be viewed as limiting but merely as explanatory. There are several variations and modifications, which may be made without departing from the scope of the present invention as, defined in the appended claims.

1. A method for recording information, the method comprising:
identifying a user based on a user ID;
tracking the user based on the user ID and a determined present location;
tagging user metadata at the identified present location; and
recording user presence at the present location.

2. The method of claim 1, further comprising:
determining whether a location of the user has changed; and
storing the recording in response to a determination that the user the location of the user has changed.

3. The method of claim 1, wherein the user ID is stored in an RFID tag.

4. The method of claim 1, wherein tagging user metadata at the identified present location comprises updating a plurality of data tables based on the present location.

5. The method 1, further comprising customizing the recording based on at least one user preference.

6. A method for generating throughput information for a user of a mobile device,
the method comprising:
receiving a request for end-to-end throughput information;
in response to the request, retrieving information on end-to-end throughput values associated with at least one access point at a plurality of locations relative to the access point;
comparing an end-to-end throughput value at a current location to throughput values at the plurality of locations; and
providing the user with one of a visual heat map and movement directions, wherein the retrieved end-to-end throughput information includes at least one reading from the mobile device or from another mobile device via a mobile-to-mobile communications link.

7. The method of claim 6, wherein the retrieved information on end-to-end throughput values is associated with a plurality of access points and wherein the plurality of access points include at least one WiFi-based access point and one cellular protocol-based access point.

8. The method of claim 6, wherein movement directions are provided to the user in response to a determination that an end-to-end throughout value at the current location is sufficiently smaller than an end-to-end throughput value associated with at least one of the plurality of locations.

9. The method of claim 6, wherein the request is automatically generated based on a determination that an end-to-end throughput value at a location other than the current location is sufficiently large.

10. The method of claim 6, further comprising:
preloading indoor floorplan data based on a location of a mobile device of the user; and
formatting a display of the visual heat map based on the retrieved floorplan data.

11. The method of claim 6, wherein the retrieved end-to-end throughput information includes at least one reading from the mobile device or via a direct mobile-to-mobile link from another mobile device in its vicinity.

12. The method of claim 6, wherein the retrieved data includes a first set of data providing relating to omni-directional reported data and a second set of data providing data relating to directional antenna reported data.

13. The method of claim 6, further comprising receiving a user toggle between a directional antenna mode and an omni-directional antenna mode and retrieving a subset of information from the database based on the mode.

14. A method for communicating advertising, the method comprising:
selecting an object affixed with an RFID tag;
receiving a unique ID of the RFID tag;
determining an advertisement associated with the unique ID of the RFID tag; and
delivering the advertisement to a user terminal.

15. The method of claim 14, further comprising:
transmitting the unique ID of the RFID tag to a server; and
receiving an advertisement from the server, the advertisement based on the unique ID.

16. The method of claim 15, further comprising sending a notification to the server regarding viewing of the advertisement.

17. The method of claim 16, further comprising providing a reward to an owner of the RFID tag.

18. The method of claim 17, further comprising displaying the advertisement on a display screen of the user terminal.

19. A method for managing mail, the method comprising:
transmitting a courier ID;
identifying a courier based on the courier ID;
retrieving courier information from the identified courier; and
sorting mail based on the courier information.

20. The method of claim 19, further comprising:
determining whether the courier information can be validated; and
unlocking a smart mailbox to deliver mail and perform enhanced functions in response to determining that the courier information can be validated.
